(19) United States
(12) Patent Application Publication
(10) Pub. No.: US 2025/0095371 A1
(43) Pub. Date: Mar. 20, 2025

(54) CAMERA EVENT PROCESSING

(71) Applicant: SimpliSafe, Inc., Boston, MA (US)

(72) Inventors: Jordan Theodore Thayer, Hopkinton, MA (US); Daniel Reid Sundell, Medford, MA (US)

(21) Appl. No.: 18/391,907

(22) Filed: Dec. 21, 2023

Related U.S. Application Data
(60) Provisional application No. 63/583,731, filed on Sep. 19, 2023.

(51) Int. Cl. G06V 20/52; G06V 10/40; G06V 10/94; G06V 20/40; G06V 40/16; G06V 40/20; H04N 7/18

(52) U.S. Cl. CPC G06V 20/52; G06V 10/40; G06V 10/945; G06V 40/172; G06V 40/20; H04N 7/183; G06V 20/41; G06V 20/46

(57) ABSTRACT

In some embodiments, a method may involve receiving, by an application executing on a computing system operated by a first user, data representing at least a first image acquired by a camera at a property and causing the computing system to output a first indication of an event at the property, the first indication including at least the first image. Based at least in part on an input by the first user indicating that the event is of a first type and preference data indicating that notifications of events of the first type are to be sent to a second user, causing, by the application, a notification concerning the event to be sent to an endpoint device associated with the second user, the notification causing the endpoint device to output a second indication of the first event.

### CROSS-REFERENCE TO RELATED APPLICATIONS

This application claims the benefit under 35 U.S.C. § 119(e) of U.S. Provisional Application No. 63/583,731, entitled CAMERA EVENT PROCESSING, filed Sep. 19, 2023, the entire contents of which are hereby incorporated by reference for all purposes.

### BACKGROUND

Some security systems enable remote monitoring of locations using cameras and other equipment.

### BRIEF DESCRIPTION OF THE DRAWINGS

Additional examples of the disclosure, as well as features and advantages thereof, will become more apparent by reference to the description herein taken in conjunction with the accompanying drawings which are incorporated in and constitute a part of this disclosure. The figures are not necessarily drawn to scale.

FIG. 1A shows an example security system configured in accordance with some implementations of the present disclosure.

FIG. 1B shows an example process for performing dependent image processing, according to some implementations of the present disclosure.

FIG. 1C is a conceptual diagram highlighting certain benefits of the security system disclosed herein.

FIG. 2 shows an example event table that may be used by the security system shown in FIG. 1A to store data related events, according to some implementations of the present disclosure.

FIG. 3 shows a first example screen that may be presented on the monitoring device of the security system shown in FIG. 1A, according to some implementations of the present disclosure.

FIG. 4 shows a detailed view of a timelapse bar shown in FIG. 3, according to some implementations of the present disclosure.

FIG. 5 shows an example dropdown menu that may be presented when a monitoring agent closes one of the event windows shown in FIG. 3, according to some implementations of the present disclosure.

FIG. 6 shows a second example screen that may be presented on the monitoring device of the security system shown in FIG. 1A, according to some implementations of the present disclosure.

FIG. 7 shows an example customer profile table that may be used by the security system shown in FIG. 1A to store data customer-specific data, according to some implementations of the present disclosure.

FIG. 8A shows a first example screen that the customer application shown in FIG. 1A may present to a customer to enable the selection of notification preferences, according to some implementations of the present disclosure.

FIG. 8B shows a second example screen that the customer application shown in FIG. 1A may present to a customer to enable the selection of notification preferences, according to some implementations of the present disclosure.

FIG. 8C shows a third example screen that the customer application shown in FIG. 1A may present to a customer to enable the selection of notification preferences, according to some implementations of the present disclosure.

FIG. 9A shows an example screen that the customer application shown in FIG. 1A may present to a customer to enable the customer to apply or more filters to view information for a subset of the events that have been detected at one or more monitored locations, according to some implementations of the present disclosure.

FIG. 9B shows an example screen that the customer application shown in FIG. 1A may present to a customer to enable the customer to view information for events that have been flagged for review by the customer, according to some implementations of the present disclosure.

FIG. 10A shows an example screen that the customer application shown in FIG. 1A may present to a customer based on selection of the “review” user interface element shown in FIG. 9B.

FIG. 10B shows an example screen the customer application shown in FIG. 1A may present to a customer based on selection of an “agent response” tab on the screen shown in FIG. 10A.

FIG. 10C illustrates how a customer may provide a particular gesture, e.g., a tap and hold gesture, on a thumbnail image on the screen shown in FIG. 10A to associate a face represented in the thumbnail image with a profile for an individual and/or to provide feedback concerning the image processing that was performed to identify a feature represented in the thumbnail image, according to some implementations of the present disclosure.

FIG. 10D shows an example screen that the customer application shown in FIG. 1A may present on the customer device in response to an input selecting a thumbnail image, such as the tab and hold gesture illustrated in FIG. 10C, according to some implementations of the present disclosure.

FIG. 11 shows an example implementation of a security system that includes several of the components shown FIG. 1A, according to some implementations of the present disclosure.

FIG. 12 shows an example implementation of the base station of the security system shown in FIG. 11, according to some implementations of the present disclosure.

FIG. 13 shows an example implementation of the keypad of the security system shown in FIG. 11, according to some implementations of the present disclosure.

FIG. 14 shows an example implementation of a security sensor of the security system shown in FIG. 11, according to some implementations of the present disclosure.

FIG. 15 shows example implementations of the surveillance center environment and the monitoring center environment of the security system shown in FIG. 11, according to some implementations of the present disclosure.

FIG. 16 is a sequence diagram of a monitoring process that may be performed by components of the security system shown in FIG. 11, according to some implementations of the present disclosure.

FIG. 17 shows example processes for establishing peer-to-peer connections between components of the security system shown in FIG. 11, to enable the streaming of video and/or audio data, according to some implementations of the present disclosure.

FIG. 18 is a sequence diagram showing an example signaling process that can be employed to establish peer-to-peer connections between components of the security system shown in FIG. 11 to enable the streaming of video and/or audio data, according to some implementations of the present disclosure.

FIG. 19 is a schematic diagram of a computing device that may be used to implement a customer device, a monitoring device, and/or one or more of the services of the of the security system shown in FIGS. 1A and 11, according to some implementations of the present disclosure.

FIG. 20 shows an example token that may be employed by various components of the system disclosed herein, according to some implementations of the present disclosure.

FIG. 21 shows an example process that may be executed by the edge image processing component and/or the remote image processing component shown in FIG. 1A, according to some implementations of the present disclosure.

FIG. 22 shows example process that may be performed by one or more components of the security system to generate the timelapse bar shown in FIG. 4, according to some implementations of the present disclosure.

FIG. 23 shows an example process that may be executed by the monitoring application shown in FIG. 1A to send notifications about events to a customer based on the notification preferences for that customer, according to some implementations of the present disclosure.

FIG. 24 shows an example process that may be executed by one or more components of the security system shown in FIG. 1A to allow a customer to specify one or more filters that are to be applied to the events presented on a screen of a customer device, according to some implementations of the present disclosure.

FIG. 25 shows an example process that may be executed by the monitoring application shown in FIG. 1A to flag events for review by a customer based on the event review preferences for that customer, according to some implementations of the present disclosure.

FIG. 26 shows an example process that may be executed by the customer application shown in FIG. 1A to enable a customer to provide feedback for use in altering one of more functionalities of an image processing component, according to some implementations of the present disclosure.

### DETAILED DESCRIPTION

Some security systems provide a mechanism to notify customers of various events that are detected at a property. Customers' smartphones, however, are already loaded with applications that inundate the customers with notifications of various types. Because security cameras tend to detect a large number of innocuous events, the addition of a camera-based app to this mix can increase the volume of such notifications significantly. The customers using such camera-based applications are forced to weed through the large volume of security event notifications they receive to separate the important notifications (e.g., notifications about actual security concerns) from the “noise” (e.g., notifications about innocuous events, such as trees blowing in the wind, authorized visitors, yard service personnel, etc.) Furthermore, upon receipt of event notifications by such applications, customers are generally required to watch and/or fast forward through video recordings to determine what happened and/or who was present. While some premium applications have added rich notifications that include a thumbnail of the first key frame that has been extracted from the video event using computer vision (CV) processing and have a pre-roll feature that starts the video approximately five seconds before the key frame was captured, because of inaccuracy in the CV processing that is employed, the users of such premium applications still tend to be inundated with a large number of irrelevant notifications. Reviewing event notifications in existing systems can thus be a tedious and time-consuming process that results in a poor customer experience.

Some existing systems use CV solutions to reduce or prioritize event notifications that are sent to customers. While helpful to some extent, the CV solutions used by such systems still allow an unacceptably large number of “noisy” notifications to reach customers. The inventors have recognized and appreciated several reasons for this performance deficiency. First, existing systems run CV processes only on a camera and/or associated base station at a monitored property. This processing may be referred to as “edge processing” or “processing at the edge.” Such edge processing tends to have self-imposed limitations to keep hardware product costs down, thus necessitating the use of CV models with limited capabilities. The use of such limited-performance CV models thus often results in erroneous or inadequate feature detection.

Additionally, existing systems generally do not include any mechanism enabling another level of verification of an event (e.g., by a monitoring agent) to determine whether the CV models accurately classified the event before a notification of the event is sent to a customer. Rather, in such systems, customers are notified immediately about all events that were detected and/or flagged as potential security concerns by CV models, without any further verification of the event.

Furthermore, in existing systems that employ CV processing to process video recordings, the customer is at no point made aware of the specific CV models that were used, the frames that were processed by such CV models, or the predictions that were made by them. This lack of transparency may drive customers to fear the unknown (e.g., whether or in what ways their privacy is being invaded) and, as a result, turn off any and all features involving CV processing.

Offered is a security monitoring system that is configured to minimize the number of irrelevant event notifications that are sent to a customer and also allow the customer to specify the types of events for which notifications are to be sent. In some implementations, the system may additionally allow the customer to understand and/or provide feedback with respect to how images from the customer's property are reviewed and analyzed. In some implementations, the system may use a combination of image processing (e.g., CV processing using one or more trained machine learning (ML) models or otherwise) and follow-on review/verification to reliably screen and categorize events detected by a security camera. For example, one or more computing devices may be configured to perform supplemental review/verification of an event and/or enable a human monitoring agent to review/verify an event after image data has been processed by one or more image processing components to allow the computing device(s)/monitoring agent to evaluate the accuracy of the feature predictions (e.g., “motion,” “person,” “face,” “recognized face”) made by those image processing component(s) as well as to categorize the event (e.g., as “emergency,” “urgent,” “trusted person,” “service/delivery person,” “unidentified person,” “common event,” etc.).

After the computing device(s)/monitoring agent has performed a supplemental review/verification of an event, a notification concerning the event may, depending on customer preference settings, be sent to a customer (e.g., as a push notification, a short message service (SMS) message, an email, a phone call, etc.). Information concerning the event may additionally or alternatively be added, again based on customer preference settings, to a list of events for the customer to review, e.g., via a mobile application. The information provided for review in this fashion may include details concerning the feature predictions that were made for the event (e.g., as a timeline showing what the image processing components predicted to have occurred at particular times) and/or a sequence of actions the monitoring agent took to review the event. The customer may also be provided with one or more user interface elements enabling the customer to provide feedback concerning the feature predictions that were made. The system may also make similar information for other events processed by the system available for review in a similar fashion and may enable the customer to apply one or more filters to specify one or more criteria, such as types of events, times at which events occurred, locations at which events occurred, cameras used to capture events, etc., to control the events for which such information is provided.

In some implementations, video/frames may be processed both on the camera and in the cloud, e.g., by a server operating in a remote computing environment. Performing image processing (e.g., CV processing using one or more trained ML models or otherwise) in the cloud may provide virtually limitless capabilities for processing the video/frames for an event from the camera. For example, the frames for an event may first be processed on the camera, allowing one or more image processing models at the edge to identify key frames, temporarily store the identified frames, and send those frames to the cloud for further processing. One or more image processing models in the cloud may then process at least the same key frames using more processing power to further eliminate event “noise.” Additional image data for the event (e.g., additional frames of recorded video) may also be processed by the cloud-based image processing model(s) as the event video recording is being shared with the cloud services, allowing additional models that are not capable of running at the edge to identify additional key frames. In some implementations, the sequence and frequency at which certain image processing models process against video/frames may sometimes depend on the outcome of the predictions of other imaging processing models. Such a multi-layer or “piggybacked” approach may further eliminate “noise” events, reduce latency in the overall system/process, and save on hosting costs.

In some implementations, customers may view a carousel of thumbnail images associated with an event, e.g., using a mobile application on a smartphone, to determine what/who was present during the event without playing and/or navigating through an event video recording. Customers may not be able to play a video for reasons such as cellular or WIFI limitations or personal situations (e.g., in a work meeting). If the customer chooses to review the event video, they may use timeline markers representing the predictions and type of predication to easily jump to that point within the event video recording. Customers may also provide feedback, e.g., by accepting or rejecting thumbnails, which may improve the image processing model performance, e.g., by using the feedback to retrain the image processing model(s), and thus further reduce noise. Customers may additionally or alternatively choose to tag images and assign them to a profile or cluster that can be used as a filter to eliminate events that contain known people which a customer considers “noise.”

Some implementations of the present disclosure provide transparency to the customer by presenting all, or nearly all, of the processed frames and predictions to the customer for individual events. Customers may filter their timeline and set notification preferences for the events that contain one or many particular types of predictions. The customer's timeline may, for example, be filtered to display only events containing the selected prediction types and the thumbnails displayed may also be filtered to show only those same prediction types. For example, for a customer who wants to view only events containing people, a timeline may be presented that shows only events that involve people and the event will show only thumbnails that contain person predictions.

For the purposes of promoting an understanding of the principles of the present disclosure, reference will now be made to the examples illustrated in the drawings, and specific language will be used to describe the same. It will nevertheless be understood that no limitation of the scope of the examples described herein is thereby intended.

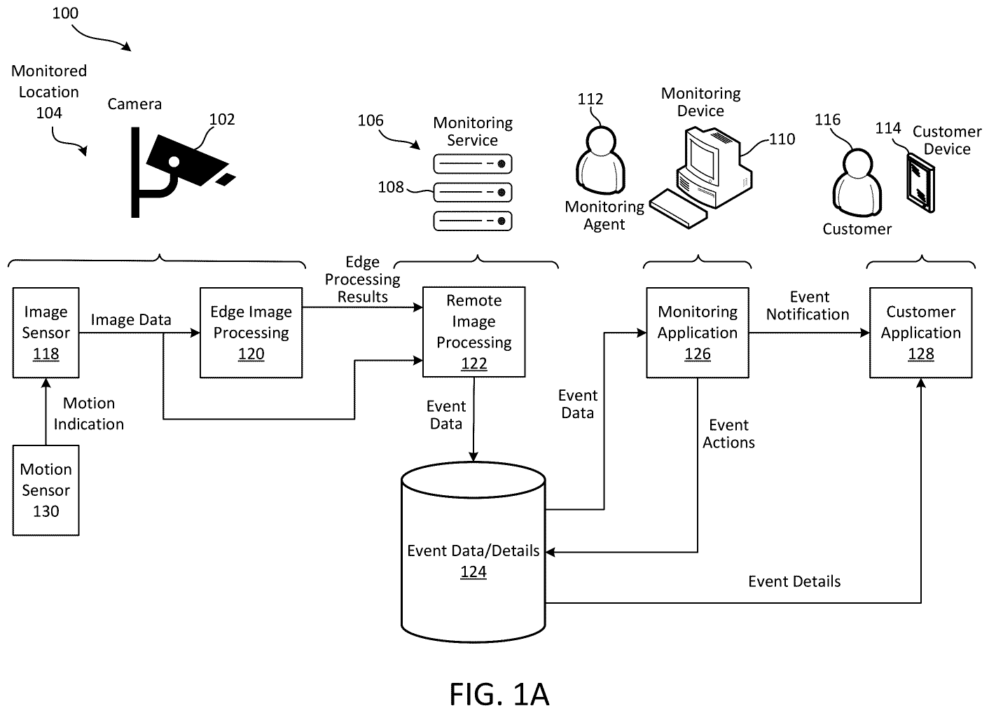

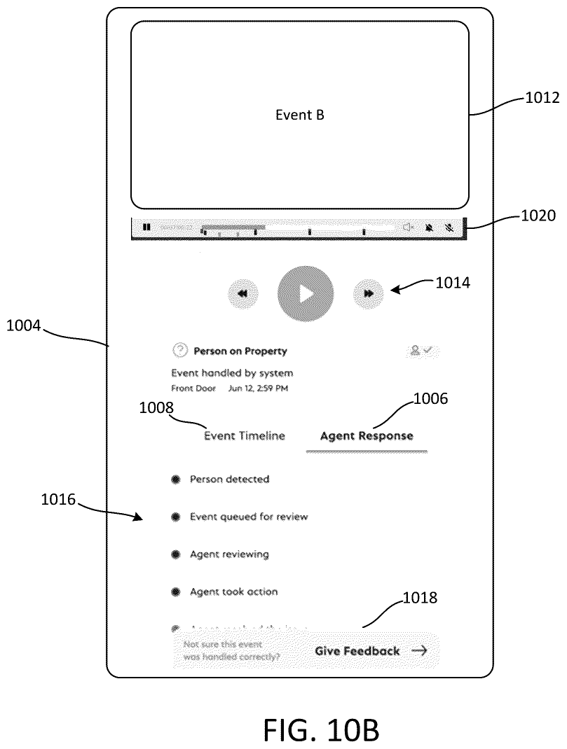

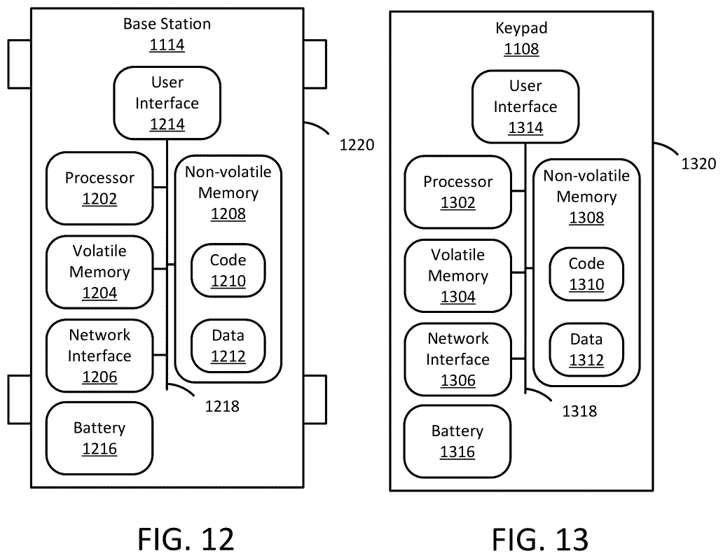

FIG. 1A shows an example security system 100 configured in accordance with some embodiments of the present disclosure. As shown, the security system 100 may include one or more cameras 102 disposed at a monitored location 104 (e.g., a residence, business, parking lot, etc.), a monitoring service 106 (e.g., including one or more servers 108) located remote from the camera(s) 102 (e.g., within a cloud-based service such as the surveillance center environment 1126 described below in connection with FIGS. 11 and 15), one or more monitoring devices 110 operated by respective monitoring agents 112, and one or more customer devices 114 operated by respective customers 116. Although not illustrated in FIG. 1A, it should be appreciated the various illustrated components may communicate with one another via one or more networks, e.g., the internet.

The camera 102 may include, among other components, a motion sensor 130, an image sensor 118, and an edge image processing component 120. The monitoring service 106 may include, among other components, a remote image processing component 122 and one or more datastores 124. The datastore(s) 124 may correspond, for example, to the location data store 1502 and/or the image data store 1504 described below in connection with FIG. 15. The monitoring device 110 may include, among other components, a monitoring application 126 (e.g., executing on one or more processors of the monitoring device 110). Finally, the customer device 114 may include, among other components, a customer application 128 (e.g., executing on one or more processors of the customer device 114). As shown, the remote image processing component 122, the monitoring application 126, and the customer application 128 may all be in communication with the datastore(s) 124, e.g., via one or more networks such as the network 1120 described below in connection with FIGS. 11 and 15. In some implementations, the monitoring service 106 or another component within the surveillance center environment 1126 (see FIGS. 11 and 15) may provide one or more application programming interfaces (APIs) that can be used by the remote image processing component 122, the monitoring application 126, and the customer application 128 to write data to the datastore(s) 124 and/or fetch data from the datastore(s) 124, as needed.

As illustrated in FIG. 1A, the image sensor 118 may acquire image data (e.g., digital data representing one or more acquired frames of pixel values) from the monitored location 104 and pass that image data to the edge image processing component 120 and/or the remote image processing component 122 for processing. In some implementations, for example, the motion sensor 130 may detect motion at the monitored location 104 and provide an indication of the detected motion to the image sensor 118. The motion sensor 130 may, for example, be a passive infrared (PIR) sensor. In response to the indication of detected motion, the image sensor 118 may begin acquiring frames of image data from within the camera's field of view. In some implementations, the image sensor 118 may continue collecting frames of image data until no motion is detected by the motion sensor 130 for a threshold period of time (e.g., twenty seconds). As a result, the image data acquired by the image sensor 118 may represent a video clip of a scene within the camera's field of view that begins when motion was first detected and ends after motion has ceased for the threshold period of time.

In some implementations, rather than relying upon a motion sensor 130 (e.g., a PIR sensor) to trigger the collection of frames of image data, the camera 102 may instead continuously collect frames of image data and rely upon one or more image processing modules (e.g., machine learning (ML) models and/or other CV processing components) of the edge image processing component 120 to process the collected frames to detect motion within the field of view of the camera 102. Accordingly, in such implementations, rather than relying upon a motion indication provided by a motion sensor 130 to determine the start and end of a video clip for further processing, the camera 120 may instead rely upon a motion indication provided by such image processing module(s) for that purpose.

The edge image processing component 120 may include one or more first image processing modules (e.g., machine learning (ML) models and/or other CV processing components) configured to identify respective features within the image data, and the remote image processing component 122 may include one or more second, different image processing modules (e.g., ML models and/or other CV processing components) configured to identify respective features within the image data. The first and/or second image processing modules may, for example, be configured to perform processing on the image data to detect motion, to identify people, to identify faces, to perform facial recognition, etc. In some implementations, the processing power of the server(s) 108 employed by the monitoring service 106 may be significantly higher than that of the processor(s) included in the edge image processing component 120, thus allowing the monitoring service 106 to employ more complex image processing modules and/or to execute a larger number of such image processing modules in parallel.

In some implementations, the processing performed by one or more of the first image processing modules of the edge image processing component 120 may be used to inform and/or enhance the processing that is performed by one or more of the second image processing modules of the remote image processing component 122. As one example, one or more of the first image processing modules of the edge image processing component 120 may perform basic processing to identity key frames within the image data that potentially represent motion, people, faces, etc., and one or more of the second image processing modules of the remote image processing component 122 may perform more complex processing only on the key frames that were identified by the one or more first image processing modules of the edge image processing component 120. As another example, one or more of the first image processing modules of the edge image processing component 120 may perform processing on the image data to identity particular frames that include motion, and one or more of the second image processing modules of the remote image processing component 122 may perform processing to detect people only on the particular frames that were identified by the one or more first image processing modules of the edge image processing component 120. As yet another example, one or more of the first image processing modules of the edge image processing component 120 may perform processing on the image data to identity particular frames that include images of people, and one or more of the second image processing modules of the remote image processing component 122 may perform processing to detect and/or recognize faces only on the particular frames that were identified by the one or more first image processing modules of the edge image processing component 120. As still another example, one or more of the first image processing modules of the edge image processing component 120 may perform processing on the image data to identity particular frames that include images of faces, and one or more of the second image processing modules of the remote image processing component 122 may perform processing to perform enhanced face recognition and/or recognize faces only on the particular frames that were identified by the one or more first image processing modules of the edge image processing component 120.

Further, in some implementations, the remote image processing component 122 may itself perform processing using multiple different image processing models, where certain of the image processing modules are dependent on the results obtained by one or more other image processing modules.

FIG. 1B is a flow chart showing an example process 131 that may be employed by the monitoring service 106 to perform dependent image processing in accordance with some implementations of the present disclosure. As shown in FIG. 1B, the process 131 may begin at a step 132, at which the monitoring service 106 may receive a next frame of recorded video data for an event from the camera 102, e.g., from the image sensor 118 or the edge image processing component 120.

At a step 134 of the process 131, the monitoring service 106 may cause one or more of the first image processing modules of the remote image processing component 122 to perform processing on the frame (and perhaps one or more adjacent frames) to determine whether the frame includes a moving object. In some implementations, for example, motion may be detected by using one or more functions of the OpenCV library (accessible at the uniform resource locator (URL) “opencv.org”) to detect meaningful difference between frames of image data.

Per a decision 136, if the monitoring service 106 determines that the frame includes a moving object, the process 131 may proceed to a step 138, at which the monitoring service 106 may cause one or more second image processing modules of the remote image processing component 122 to perform processing on the frame to determine whether the frame includes a person. If, however, the monitoring service 106 determines (at the decision 136) that the frame does not include a moving object, the process 131 may instead terminate. One example of an ML model that may be used for person detection is YOLO (accessible via the URL “github.com”).

Per a decision 140, if the monitoring service 106 determines that the frame includes a person, the process 131 may proceed to a step 142, at which the monitoring service 106 may cause one or more third image processing modules of the remote image processing component 122 to perform processing on the frame to determine whether the frame includes a face. If, however, the monitoring service 106 determines (at the decision 140) that the frame does not include a person, the process 131 may instead terminate. One example of an ML model that may be used for face detection is RetinaFace (accessible via the URL “github.com”).

Per a decision 144, if the monitoring service 106 determines that the frame includes a face, the process 131 may proceed to a step 146, at which the monitoring service 106 may cause one or more fourth image processing modules of the remote image processing component 122 to perform enhanced facial recognition processes to more accurately identify and locate the face in the frame. If, however, the monitoring service 106 determines (at the decision 144) that the frame does not include a face, the process 131 may instead terminate. One example of an ML model that may be used for enhanced face detection is MTCNN_face_detection_alignment (accessible via the URL “github.com”).

Finally, after the one or more fourth image processing modules of the remote image processing component 122 more accurately identify and locate the face in the frame per the step 146, the process 131 may proceed to a step 148, at which the monitoring service 106 may cause one or more fifth image processing modules of the remote image processing component 122 to perform facial recognition on the frame (e.g., by generating biometric embeddings of the detected face and comparing those embeddings against a library of known faces) to attempt to determine an identify of the person based on the identified face. One example of an ML model that may be used for facial recognition is AdaFace (accessible via the URL “github.com”).

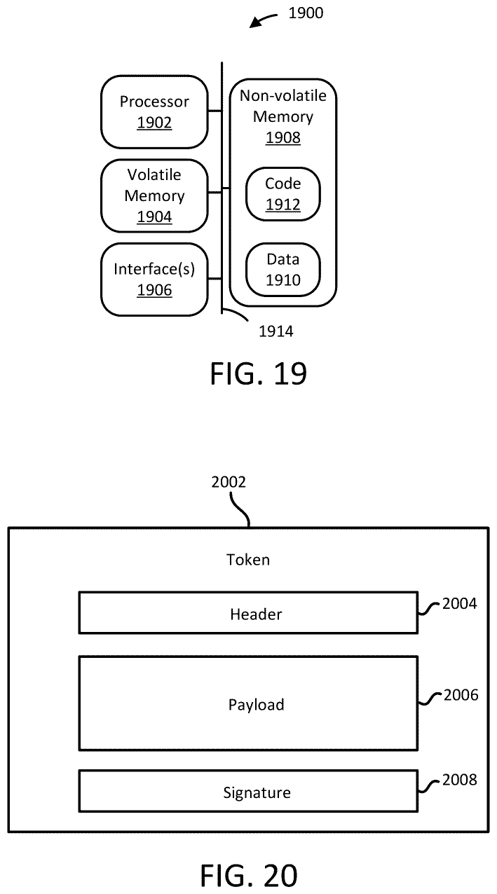

Another example process 2100 that may be executed by the edge image processing component 120 and/or the remote image processing component 122 is described below in connection with FIG. 21.

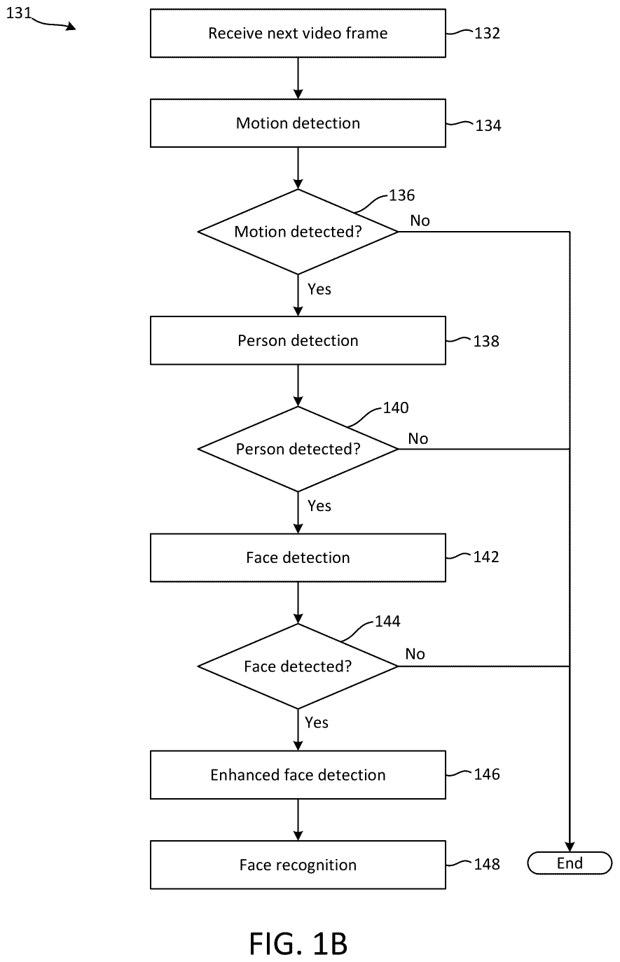

After the remote image processing component 122 has detected and/or confirmed the presence of one or more pertinent features (e.g., motion, people, faces, recognized faces, etc.) within the image data, the remote image processing component 122 may upload the image data as well as data reflecting the identified features (collectively “event data”) to the one or more datastores 124 (e.g., to a row of an event table 202—described below in connection with FIG. 2) for further review (e.g., by a monitoring agent 112 operating a monitoring application 126 and/or a customer 116 operating a customer application 128). In other implementation, image data (e.g., video corresponding to motion detected by the motion sensor 130) may be uploaded to the datastore(s) 124 (e.g., to respective rows of the event table 202) as it is acquired, and the remote image processing component 122 may simply supplement the uploaded image data (e.g., by populating one or more columns of the event table 202) with data concerning the feature(s) the remote image processing component 122 identifies.

FIG. 1C is a conceptual diagram highlighting certain benefits of the security system 100 disclosed herein. As shown in FIG. 1C, in some implementations, the sending of a notification (e.g., via a push notification service 150, an email service 152, a short message service (SMS) 154, or an audio or telephone service 156) to a customer device 114 may be delayed to allow for processing/review of image data acquired by a camera 120 by a remote image processing component 122 and/or a monitoring agent 112 operating a monitoring device 110. This may be contrasted with a conventional approach in which, upon detecting a motion event, a camera immediately sends a push notification directly to a customer device. The additional processing performed by the remote image processing component 122 and/or the monitoring agent 112 may allow the remote image processing component 122 and/or the monitoring agent 112 to add additional context or descriptive information to one or more notifications 158a, 158b that are sent to the customer device 114, as well as allow for the selection (e.g., via the monitoring device 110) of an appropriate delivery method for such notifications(s) 158, e.g., via the push notification service 150, the email service 152, the SMS service 154, or the audio service 156.

FIG. 2 shows an example event table 202 that may be used to store the event data for various events detected by the system 100. As shown, for individual events, the event table 202 may be populated with data representing, among other things, an event identifier (ID) 204, a timestamp 206, a location ID 208, a camera ID 210, image data 212, one or more feature predictions 214, one or more agent actions 216, a cancelation reason 218, an event disposition 220, a customer review status 222, and customer feedback 224.

The event IDs 204 may represent the different events that the security system 100 has detected, and the data in the same row as a given event ID 204 may correspond to that same event.

The timestamps 206 may indicate the date and time at which the corresponding event was detected.

The location IDs 208 may identify the monitored location 104 at which the event was detected.

The camera IDs 210 may identify the cameras 102 that are associated with the corresponding detected events.

The image data 212 may represent one or more images (e.g., snapshots or video) that were acquired by the camera 102 identified by the corresponding camera ID 210 when the event was detected.

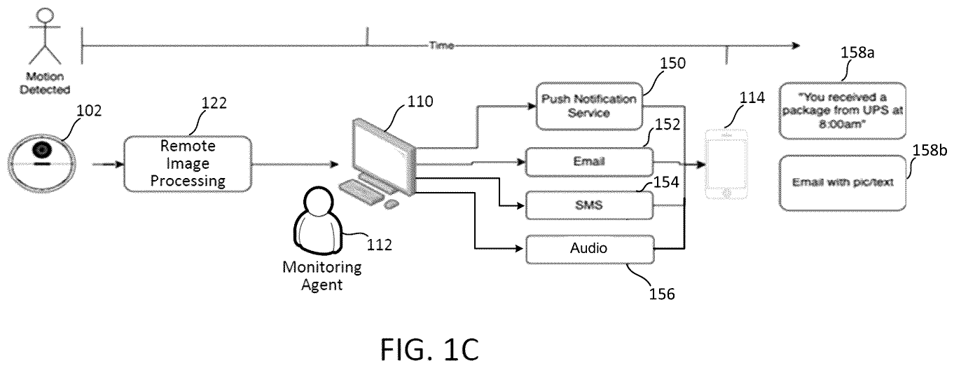

The feature prediction(s) 214 may include information concerning one or more features identified by the edge image processing component 120 and/or the remote image processing component 122. Such information may include, for example, indicators of detected motion during the event, indicators of detected people corresponding to the event, indicators of detected faces corresponding to the event, a threat level assigned to the event, etc. In some implementations, the feature predictions 214 may further include information identifying the temporal positions within a video clip at which respective features were identified by the edge image processing component 120 and/or the remote image processing component 122. As explained below in connection with FIGS. 3, 4, 6, 9A, 9B, 10A and 10B, such timing information may be used, for example, to present one or more feature indicators 408, 1034 at appropriate locations on a timelapse bar 310, 1020, to allow playback of a video clip beginning at or shortly before a time at which the feature was identified (e.g., in response to selection of a feature indicator 408, 1034, a thumbnail image 1022, a feature descriptor 1036, a time indicator 1038 or other UI element corresponding to the identified feature), and/or to correlate feature identifiers with thumbnail images for presentation to a monitoring agent 112 (e.g., via a monitoring application 126) and/or a customer 116 (e.g., via a customer application 128).

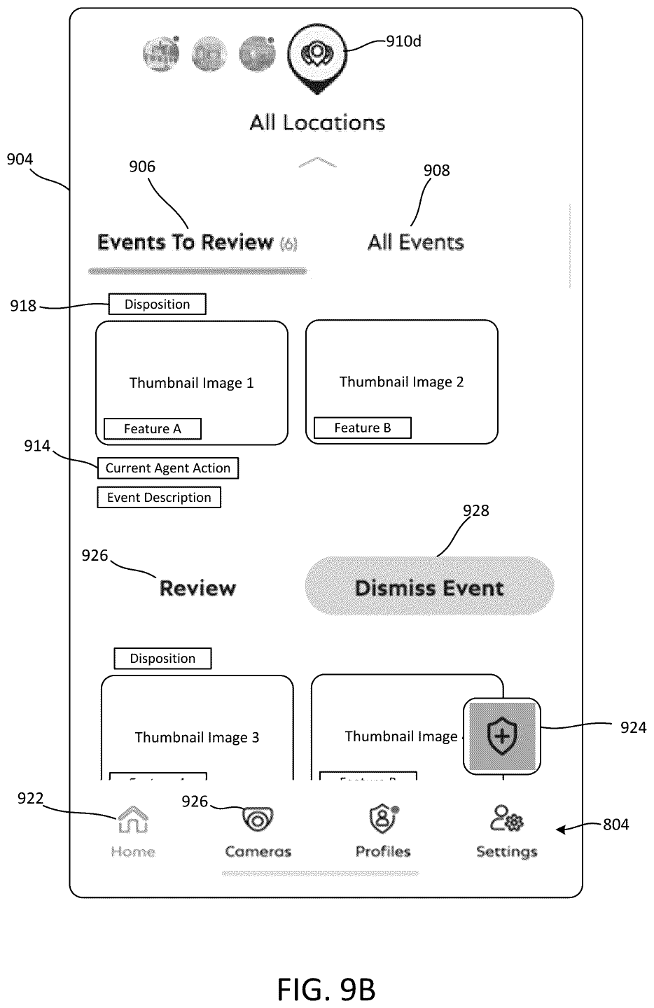

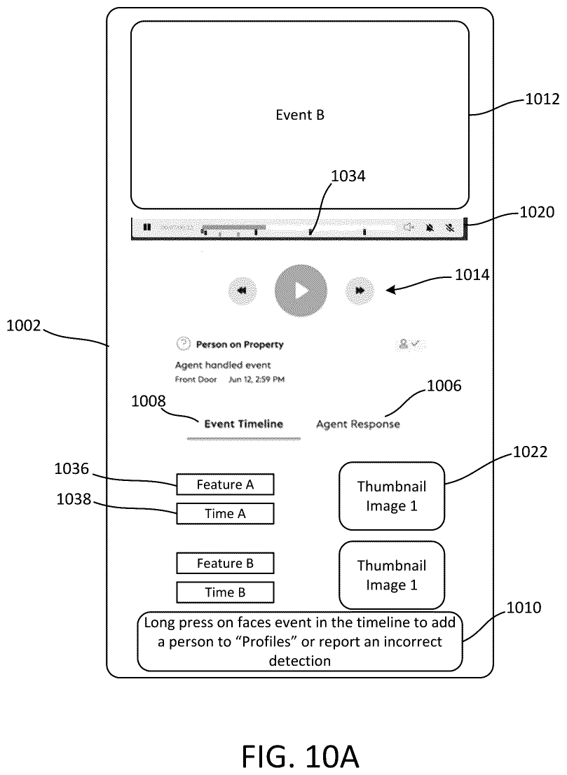

The agent action(s) 216 may represent one or more actions taken by monitoring agents 112 during their review of events. The agent action(s) may include, for example, an indication that a monitoring agent 112 is verifying an event (e.g., when an event is in the monitoring agent's queue of events to review), an indication that the event is being actively reviewed by a monitoring agent 112 (e.g., when the monitoring agent is viewing a live camera feed from the monitored location 104), an indication that a monitoring agent 112 is following up on the event (e.g., to provide a notification to the user and/or finalize the disposition of the event), and an indication that the monitoring agent 112 resolved the event, etc. As explained below in connection with FIGS. 9A and 9B, in some implementations, this information may be used to provide real-time, or near real-time, status information to the customer 116 (e.g., via the customer application 128) concerning what the monitoring agent 112 is currently doing to address an event detected by the security system 100. Further, as explained below in connection with FIG. 10B, this data may additionally or alternatively be used, possibly with other data (e.g., the feature prediction(s) 214, data indicating when an event was placed in a monitoring agent's queue for review, etc.), to generate the information 1016 for an “agent response” description that may be presented on a customer device 114 (e.g., via a customer application 128).

The cancelation reason 218 may represent a reason that a monitoring agent 112 provides for determining that an event does not present a security concern. As explained below in connection with FIGS. 3, 5 and 6, such a reason may be provided, for example, when a monitoring agent 112 selects a close element 312 of an event window 306 of the monitoring agent's review queue, or determines that a security concern does not exist after reviewing live video from the monitored location within one or more video feed windows 604 or a main viewer window 606 and/or after reviewing one or more event data windows 608.

The event disposition 220 may represent the disposition of the event after review by the monitoring agent 112. The event disposition 220 may indicate, for example, that the event is an emergency event (e.g., when a life threatening or violent situation is taking place) or an urgent event (e.g., package theft, property damage, or vandalism), that the event was handled by the monitoring agent 112, that the police or fire department was dispatched, the event was canceled after a person accurately provided a safe word, that the event was canceled by the customer 116 (e.g., via the customer application 128), etc. As discussed in more detail below, in some implementations, the noted event disposition 220 may be used, for example, to determine whether to send a notification (e.g., a push notification, SMS message, email, etc.) to the customer 116, whether to tag the event for review by the customer 116 (e.g., on the “events to review” screen 904 shown in FIG. 9B), enable the filtering of events based on one or more customer specified criteria (e.g., via the “type of event” user interface element 912c on the screen 902 shown in FIG. 9A), and/or to populate various fields that can be included on the screens 902, 904, 1002, 1004 shown in FIGS. 9A, 9B, 10A and 10B.

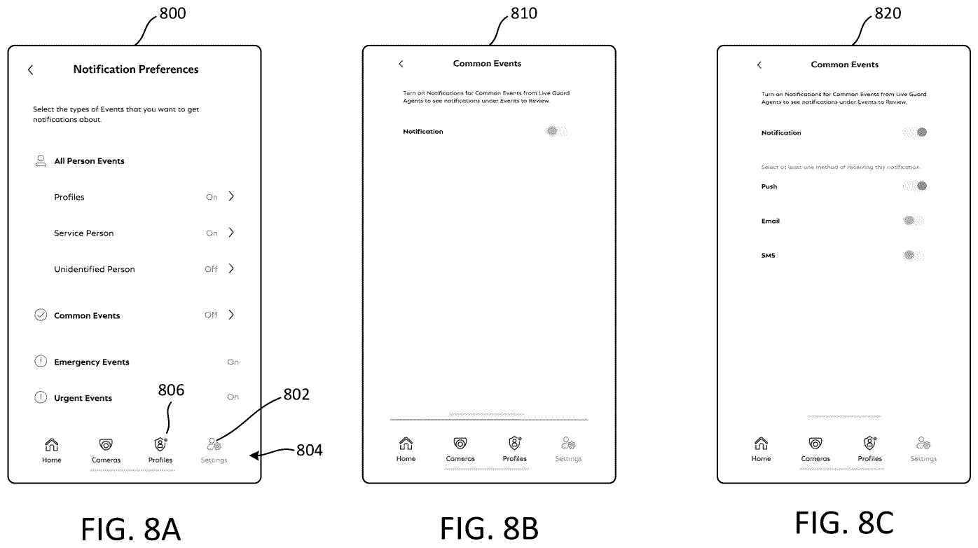

The customer review status 222 may indicate, for example, that an event is awaiting review by the customer 116 (e.g., by being present in an “events to review” queue—see FIG. 9B), that the event has already been reviewed and “dismissed” by the customer 116 (e.g., as described below in connection with FIG. 9B), or that the event has not been flagged for review by the customer. As described in more detail below in connection with FIGS. 7 and 9B, whether a particular event is queued for review by a given customer 116 may be determined based on notification preferences 704 and/or event review preferences 706 that may be set by or for respective customers 116.

The customer feedback 224 may represent information provided by the customer 116 based on the customer's review of the event (e.g., via a customer application 128). As described below in connection with FIGS. 10A and 10B, for example, in some implementations, customers may identify instances in which they believe the edge image processing component 120 and/or remote image processing component 122 incorrectly identified a feature, or may indicate whether or how they believe an event may have been handled incorrectly by a monitoring agent 112. In some implementations, the customer feedback 224 may be used to retrain or otherwise modify the image processing modules (e.g., ML model(s) and/or other CV processing component(s)) that were used to identify the feature, to enable the training, or retraining, of monitoring agents 112, etc.

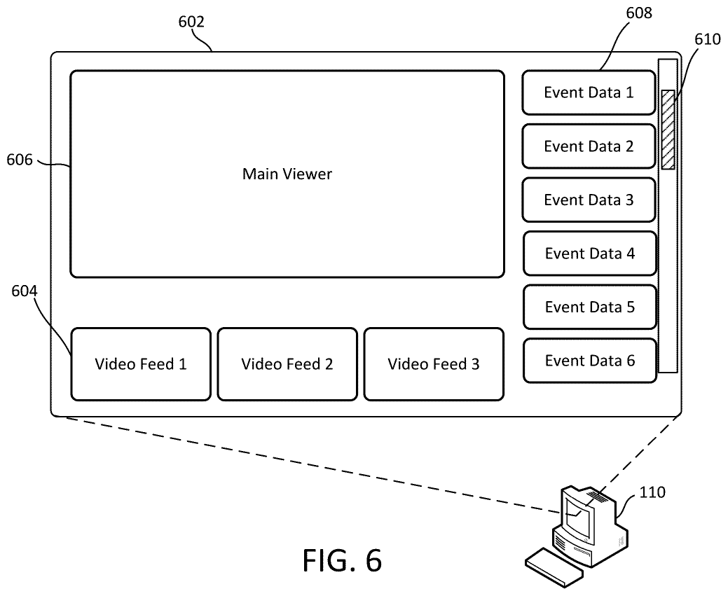

Although not illustrated in FIG. 2, it should be appreciated that the event table 202 may additionally include other data that can be used for various purposes, such as facilitating the assignment of events to particular agents, descriptions of the events (e.g., “Back Yard Camera Detected Motion”), alarm statuses for the monitored locations 104, one or more recorded audio tracks associated with the events, status changes of one or more sensors (e.g., door lock sensors) at monitored locations 104, etc. As described in more detail below in connection with FIG. 6, in some implementations, some such data may be used to populate one or more event data windows 608 that can be displayed by a monitoring device 110, together with one or more live video feeds within the video feed window(s) 604 and/or the main viewer window 606.

Notifications concerning “actionable” events represented in the event table 202 (e.g., events for which the remote image processing component 122 identified one or more features of interest) may be dispatched to respective monitoring applications 126 for review by monitoring agents 112. In some implementations, the monitoring service 106 may use the contents of the event table 202 to assign individual events to various monitoring agents 112 who are currently on-line with monitoring applications 126. The monitoring application 126 operated by a given monitoring agent 112 may then add the events assigned to that monitoring agent 112 to a queue of events for review by that monitoring agent 112. When an event is added to a monitoring agent's review queue, the monitoring application 126 may cause an indication that the event is being verified by the monitoring agent 112 to be added be added to the event table 202 as an agent action 216. As discussed in more detail below in connection with FIGS. 9A, 9B, and 10B, in some implementations, the noted agent action 216 may be used to cause the customer application 128 to provide real-time, or near real-time, information 914 concerning the action being taken by the monitoring agent 112 and/or to provide historical information 1016 concerning the actions the monitoring agent 112 took while reviewing the event.

FIG. 3 shows an example screen 302 that may be presented on a monitoring device 110 of the security system 100. As shown, the monitoring device 110 may be operated by a monitoring agent 112, and the screen 302 may include a set of event windows 306 corresponding to respective events that are currently in the monitoring agent's queue for review. In some implementations, for example, the individual event windows 306 may be configured to play back recorded video corresponding to respective events that were detected at various monitored locations 104. As used herein, a “monitored location” may correspond to a particular location (e.g., a house and associated lot, an office space, a parking lot, etc.) that is monitored for security or other purposes. A given monitored location 104 may, for example, be associated with a particular customer (e.g., via a customer ID). In some implementations, the recorded video may, at least initially, be configured and/or played back at an increased rate (e.g., two times standard speed) to increase the rate at which monitoring agents 112 can review the video for potential threats or objects of interest.

As shown in FIG. 3, in some configurations, the screen 302 may include a controls interface 308 that includes one or more user interface (UI) elements to allow the monitoring agent 112 to control various aspects of that agent's queue, such as a maximum number of notifications that can be added to the agent's queue for presentation in respective event windows 306. In some implementations, event notifications may be distributed to individual monitoring agents 112, who are included in a pool of available monitoring agents 112, so that all of the available monitoring agents 112 have roughly the same number of events in their review queue at a given time.

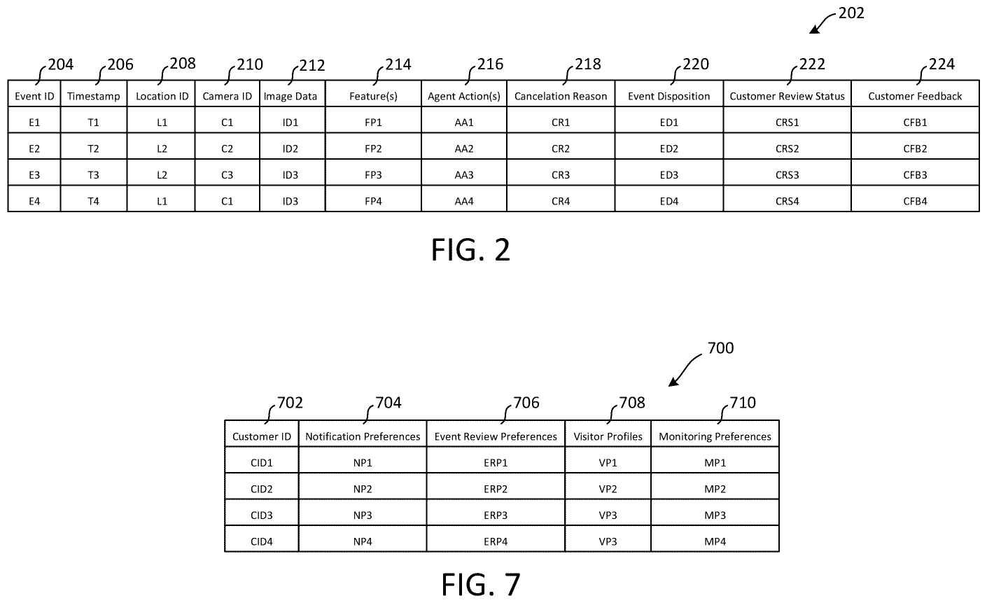

As also shown in FIG. 3, in some implementations, the individual event windows 306 may include timelapse bars 310 that include various features and controls to facilitate review of the video being presented in the event windows 306. A detailed view of an example timelapse bar 310 is shown in FIG. 4. As shown in FIG. 4, the timelapse bar 310 may include a playback progress indicator 402 and an associated time indicator 404 showing the temporal location of the currently displayed image within the recorded video clip. In the illustrated example, the playback progress indicator 402 and the time indicator 404 indicate that the current image is from the seventh second of a video clip that is twenty-two seconds long. The timelapse bar 310 may further include play/pause button 406 that may be selected to toggle between a “play” mode in which the video clip is played back and a “pause” mode in which playback of the video clip is paused at a particular frame. The monitoring agent 112 may additionally navigate to a particular temporal location within the recorded video clip by selecting (e.g., clicking on) a particular location on the playback progress indicator 402.

Advantageously, the timelapse bar 310 may additionally include feature indicators 408a, 408b, 408c corresponding to features of the image data that were identified by one or more image processing modules of the edge image processing component 120 and/or the remote image processing component 122. In some implementations, the colors and/or vertical positions of the respective feature indicators 408 may signify the type of feature prediction that was made. For instance, in the illustrated example, the feature indicator 408a may correspond to the detection of a person by the edge image processing component 120 and/or remote image processing component 122, the feature indicator 408b may correspond to the detection of motion by the edge image processing component 120 and/or remote image processing component 122, and the feature indicator 408c may correspond to the detection of a face by the edge image processing component 120 and/or remote image processing component 122. The inclusion of such feature indicators 408 allow the monitoring agent 112 to quickly navigate to and review the portions of the video clip that the edge image processing component 120 and/or the remote image processing component 122 identified as including particular features of potential interest. As noted above, data enabling the presentation of the feature indicators 408 may be stored as feature predictions 214 of the event table 202.

In some implementations, when the edge image processing component 120 and/or the remote image processing component 122 identify a feature in a frame of the image data acquired by the image sensor 118, metadata identifying the relative position of the frame within the sequence of frames acquired for the event (e.g., a frame identifier or a timestamp) may be stored as a component of the feature predictions 214, thus enabling the placement of the corresponding feature indicator 408 at the correct relative location on the timelapse bar 310. The monitoring application 126 may thus be configured such that selection of one of the displayed feature indicators 408 causes playback of the recorded video to begin at or shortly before a time at which the corresponding feature was identified. Although not illustrated in FIG. 3, in some implementations, the screen 302 may additionally or alternatively present one or more other UI elements corresponding to identified features (e.g., thumbnail images, feature descriptors, and/or time indicators similar to the thumbnail images 1022, feature descriptors and/or time indicators 1036 described below in connection with FIG. 10A) that may similarly be selected to cause playback of the recorded video to begin at or shortly before a time at which the corresponding feature was identified.

In some implementations, customers 116 operating customer devices 114 may likewise be provided with a timelapse bar 310 including the same or similar features, including the feature indicators 408a, 408b, 408c, when presented with a video clip in response to selecting an event under the “events to review” tab 906 or the “all events” tab 908, as described further below in connection with FIGS. 9A and 9B.

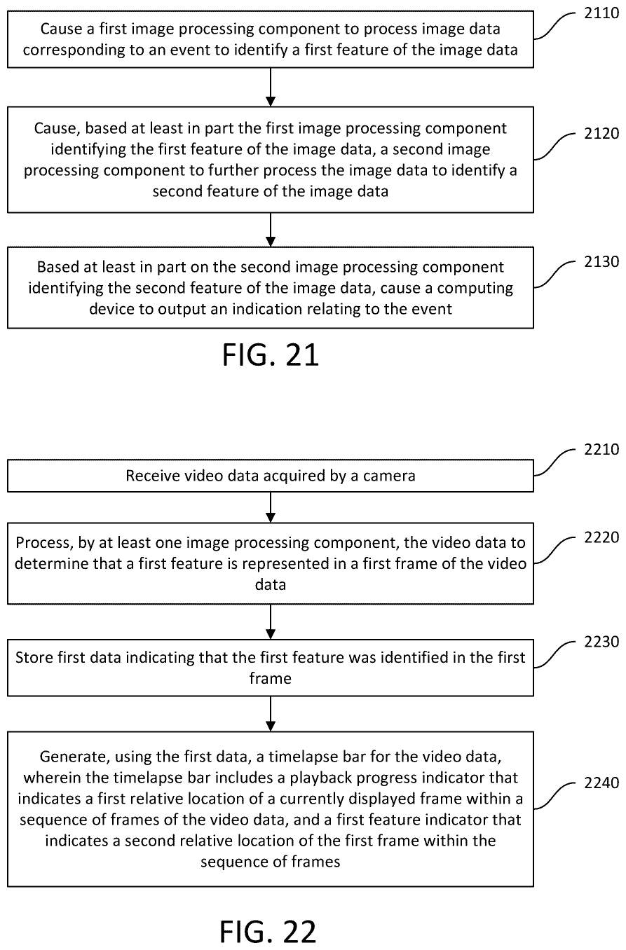

An example process 2200 that may be performed by one or more components of the security system 100 to generate the timelapse bar 310 is described below in connection with FIG. 22.

Upon reviewing one of the event windows 306, e.g., by viewing a recorded video clip corresponding to detected motion, the monitoring agent 112 may determine that no potential security threat exists and provide an input instructing monitoring application 126 to cause the event notification to be removed from the agent's review queue, thus freeing up the corresponding event window 306 to display another event notification. Such an input may, for example, involve selecting (e.g., clicking on) a close element 312 of an event window 306.

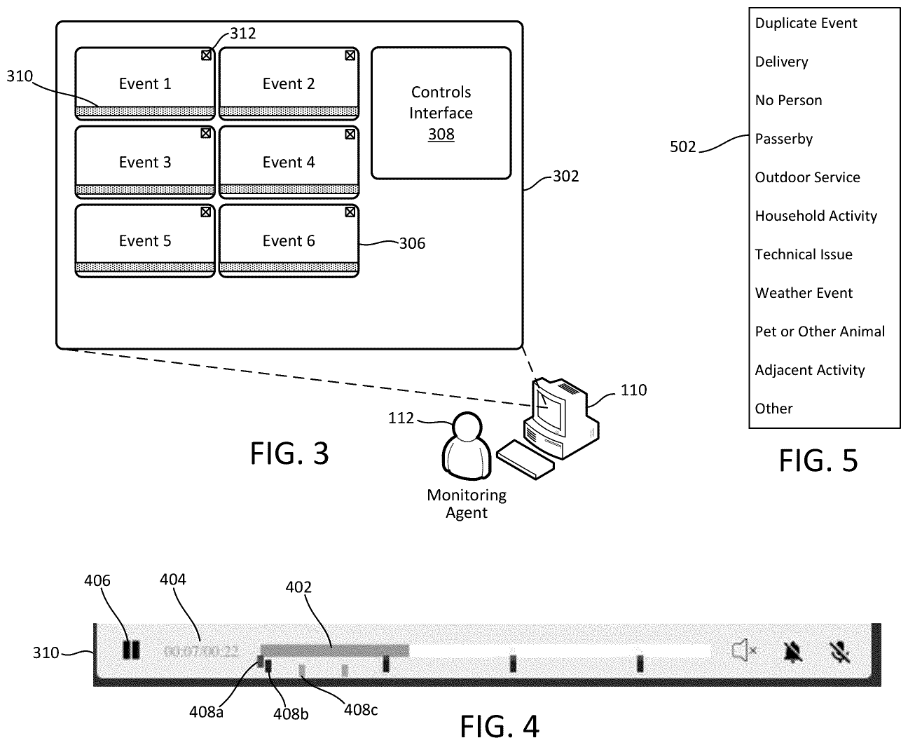

In some implementations, the monitoring agent 112 may identify reasons why individual notifications are to be removed from the agent's queue, e.g., by selecting an option from a dropdown menu presented upon selecting the close element 312. FIG. 5 shows an example dropdown menu 502 that may be presented on the screen 302 in response to selecting a close element 312. As indicated, examples of reasons that may be provided for canceling an event notification include “duplicate event,” “delivery,” “no person,” “passerby,” “outdoor service,” “household activity,” “technical issue,” “weather event,” “pet or other animal,” “adjacent activity,” and “other.” In response to the selection of such a reason by the monitoring agent 112, the monitoring application 126 may enter an indication of the reason as a cancelation reason 218 for the notification in the event table 202. As discussed in more detail below, in some implementations, the noted cancelation reason 218 may be used, for example, to determine whether to send a notification (e.g., a push notification, SMS message, email, etc.) to the customer 116, whether to tag the event for review by the customer 116 (e.g., on the “events to review” screen 904 shown in FIG. 9B), and/or to enable the filtering of events based on one or more customer specified criteria (e.g., via the “type of event” user interface element 912c on the screen 902 shown in FIG. 9A).

The monitoring application 126 may additionally enter an indication that the event has been resolved by the monitoring agent 112 as an agent action 216 in the event table 202. As discussed in more detail below in connection with FIGS. 9A, 9B, and 10B, in some implementations, the noted agent action 216 may be used to cause the customer application 128 to provide real-time, or near real-time, information 914 concerning the action being taken by the monitoring agent 112 and/or to provide historical information 1016 concerning the actions the monitoring agent 112 took while reviewing the event.

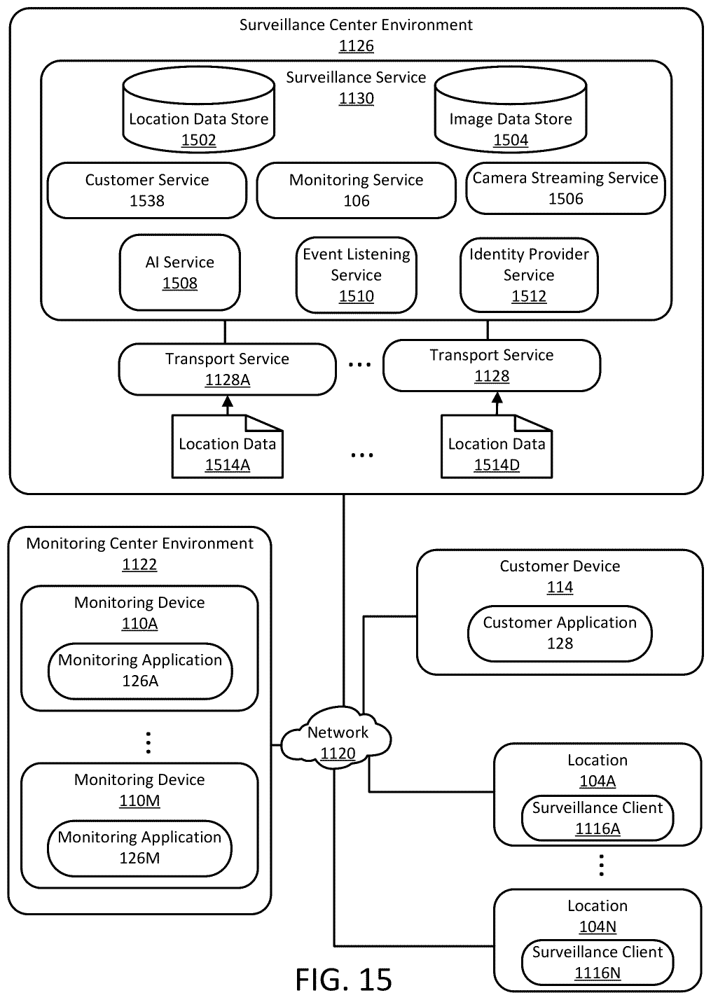

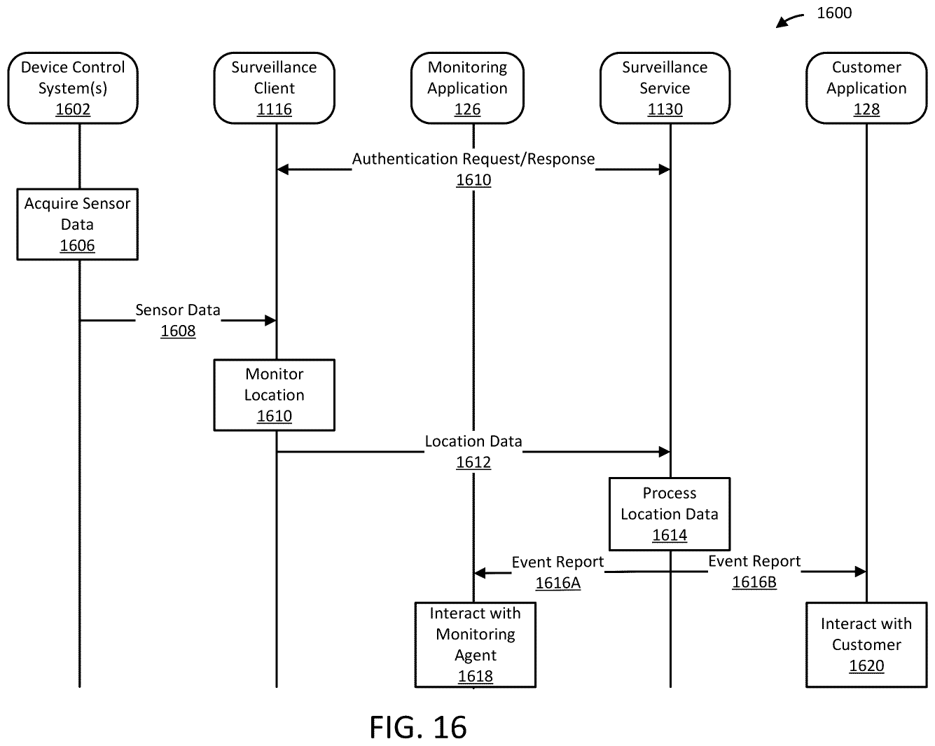

Alternatively, upon reviewing one of the event windows 306, e.g., by viewing a recorded video clip corresponding to detected motion, the monitoring agent 112 may determine that a potential threat or other security concern (referred to herein as an “incident”) exists and determine that further review is warranted. In such a circumstance, the monitoring agent 112 may click on or otherwise select the event window 306 in which the recorded video in question is being displayed. In response to such a selection, the monitoring device 110 may begin to receive live video and/or audio streamed from one or more cameras at the monitored location 104 and/or the monitoring agent 112 may otherwise be provided with additional data (e.g., other recorded video and/or audio, still images, sensor data, artificial intelligence (AI) evaluation results from the edge image processing component 120 and/or the remote image processing component 122, etc.) enabling the monitoring agent 112 to evaluate whether the incident presents an actual security risk. In some implementations, for example, one or more peer-to-peer connections may be established between one or more cameras 102 at the monitored location 104 and the monitoring device 110, e.g., using web real-time communication (WebRTC) functionality of a browser on the monitoring device 110, to enable the streaming of video data and/or audio data between such camera(s) 102 and the monitoring device 110. An example process for securely establishing a peer-to-peer connection between the monitoring device 110 and a camera 102 to enable such live-streaming is described below in connection with FIGS. 17 and 18. When a monitoring agent 112 begins reviewing an event (e.g., by selecting an event window 306), the monitoring application 126 may cause an indication that the event is being actively reviewed by the monitoring agent 112 to be added to the event table 202 as an agent action 216. As discussed in more detail below in connection with FIGS. 9A, 9B, and 10B, in some implementations, the noted agent action 216 may be used to cause the customer application 128 to provide real-time, or near real-time, information 914 concerning the action being taken by the monitoring agent 112 and/or to provide historical information 1016 concerning the actions the monitoring agent 112 took while reviewing the event.

FIG. 6 shows an example screen 602 that may be presented by the monitoring device 110 in response to selection of one of the event windows 306 shown in FIG. 3. In the illustrated example, the screen 602 includes three video feed windows 604 configured to display streamed video from three different cameras 102 at the monitored location 104 corresponding to the selected event window 306. Although not illustrated in FIG. 6, controls may additionally or alternatively be provided to allow the monitoring agent 112 to listen to streamed audio from the corresponding camera(s) 102 as well as to speak into a microphone so as to cause one or more speakers of such camera(s) 102 to output audio representing to the monitoring agent's voice. In the illustrated example, the screen 602 also includes a larger, main viewer window 606 in which the streamed video for one of the video feed windows 604 may optionally be played, thus making it easier for the monitoring agent 112 to see the content of the video. In some implementations, the monitoring agent 112 may cause the streamed video from a particular camera 102 to be played in the main viewer window 606 by selecting the video feed window 604 for that camera, e.g., by clicking on it.

As shown in FIG. 6, in some implementations, the monitoring application 126 may cause the screen 602 of the monitoring device 110 to present one or more event data windows 608 containing additional information concerning the event. Such additional information may include, for example, image frames that were identified by the edge image processing component 120 and/or the remote image processing component 122 as including features of interest (e.g., motion, people, faces, etc.), indications of outputs from other sensors (e.g., door sensors, glass break sensors, motion sensors, smoke detectors, etc.) at the monitored location 104, images of individuals authorized to be at the monitored location 104, etc. Further, as also illustrated, in some implementations, the monitoring application 126 may cause the screen 602 of the monitoring device 110 to present a scroll bar 610 that a monitoring agent 112 can manipulate, e.g., to access and review additional event data windows 608 than cannot fit within the display region of the monitoring device 110.

The monitoring agent 112 may take an appropriate action based on a review of the live video and/or audio from the camera(s) 102. If the monitoring agent 112 determines that no security issue exists, the monitoring agent 112 may cancel the event notification (e.g., by clicking on or otherwise selecting a “cancel” button—not illustrated), thus causing it to be removed from that agent's queue. In response to selection of such a cancel button, the monitoring application 126 may cause the screen 602 to present a dropdown menu that is the same as or similar to the dropdown menu 502 described above, thus allowing the monitoring agent 112 to select a reason for canceling the notification. Once again, in response to the selection of such a reason by the monitoring agent 112, the monitoring application 126 may enter an indication of the reason as a cancelation reason 218 for the notification in the event table 202, and may additionally enter an indication that the event has been resolved by the monitoring agent 112 as an agent action 216 in the event table 202. As discussed in more detail below, in some implementations, the noted cancelation reason 218 may be used, for example, to determine whether to send a notification (e.g., a push notification, SMS message, email, etc.) to the customer 116, whether to tag the event for review by the customer 116 (e.g., on the “events to review” screen 904 shown in FIG. 9B), and/or to enable the filtering of events based on one or more customer specified criteria (e.g., via the “type of event” user interface element 912c on the screen 902 shown in FIG. 9A). Further, as discussed in more detail below in connection with FIGS. 9A, 9B, and 10B, in some implementations, the noted agent action 216 may be used to cause the customer application 128 to provide real-time, or near real-time, information 914 concerning the action being taken by the monitoring agent 112 and/or to provide historical information 1016 concerning the actions the monitoring agent 112 took while reviewing the event.

If, on the other hand, the monitoring agent 112 continues to believe, based on a review of the live video and/or audio from the camera(s) 102, that a threat or other security issue may exist, the monitoring agent 112 may instead determine to continue evaluating the event, such as by verbally communicating with one or more individuals at the monitored location 104, e.g., via a speaker on a camera 102. In some implementations, the monitoring application 126 may present a user interface element (e.g., a “continue” button—not illustrated) that the monitoring agent 112 can click or otherwise select to indicate that the monitoring agent 112 is continuing to review the event. When that user interface element is selected, the monitoring application 126 may enter an indication that the monitoring agent 112 is “taking an action” as an agent action 216 in the event table 202. As discussed in more detail below in connection with FIGS. 9A, 9B, and 10B, in some implementations, the noted agent action 216 may be used to cause the customer application 128 to provide real-time, or near real-time, information 914 concerning the action being taken by the monitoring agent 112 and/or to provide historical information 1016 concerning the actions the monitoring agent 112 took while reviewing the event. In some implementations, upon selecting the “continue” user interface element, the monitoring application 126 may present the monitoring agent 112 with authentication information that can be used to help determine whether an individual at the monitored location 104 is authorized to be there. Such authentication information may include, for example, contact information for the customer, a safe word set by the customer, etc.

Upon further review by the monitoring agent 112, interaction with one or more individuals at the monitored location 104, etc., the monitoring agent 112 may determine a disposition of the event and possibly take one or more remedial measures, such as dispatching the police or fire department to the monitored location 104. In some implementations, the monitoring application 126 may present a user interface element (e.g., a “handled” button—not illustrated) to allow the monitoring agent 112 to indicate when the monitoring agent 112 has determined a disposition for the event. In response to selecting that user interface element, the monitoring application 126 may enter an indication that the event has been handled by the monitoring agent 112 as an agent action 216 in the event table 202. As discussed in more detail below in connection with FIGS. 9A, 9B, and 10B, in some implementations, the noted agent action 216 may be used to cause the customer application 128 to provide real-time, or near real-time, information 914 concerning the action being taken by the monitoring agent 112 and/or to provide historical information 1016 concerning the actions the monitoring agent 112 took while reviewing the event.

Further, in some implementations, the monitoring application 126 may prompt the monitoring agent 112 to send one or more follow-up communications (e.g., an email, a push notification, a text message, etc.) to the customer 116 describing the event and its disposition. In some implementations, the monitoring application 126 may additionally prompt the monitoring agent 112 to select one or more key frames including features identified by the edge image processing component 120 and/or the remote image processing component 122 (e.g., by using toggle switches to select such items amongst the event data windows 608), and may append the selected frame(s) and indications of the feature(s) to the notification that is sent to the customer 116.

In some implementations, the monitoring application 126 may also present user interface elements (e.g., toggle switches) allowing the monitoring agent 112 to flag frames identified by the edge image processing component 120 and/or the remote image processing component 122 as having including incorrect or inaccurate feature identifications, and the data that is so collected may subsequently be used to retrain the edge image processing component 120 and/or the remote image processing component 122.

Further, in some implementations, the monitoring application 126 may prompt the monitoring agent 112 to identify a final disposition for the event (e.g., by selecting a disposition from a dropdown menu or other list of possible dispositions). The monitoring application 126 may enter an indication of the final disposition the monitoring agent 112 identifies as an event disposition 220 in the event table 202. As discussed in more detail below, in some implementations, the noted event disposition 220 may be used, for example, to determine whether to send a notification (e.g., a push notification, SMS message, email, etc.) to the customer 116, whether to tag the event for review by the customer 116 (e.g., on the “events to review” screen 904 shown in FIG. 9B), enable the filtering of events based on one or more customer specified criteria (e.g., via the “type of event” user interface element 912c on the screen 902 shown in FIG. 9A), and/or to populate various fields that can be included on the screens 902, 904, 1002, 1004 shown in FIGS. 9A, 9B, 10A and 10B.

In some implementations, the monitoring application 126 may initially prompt the monitoring agent 112 to indicate a final disposition for the event, and may prompt the monitoring agent 112 to provide one or more follow-up communications only if preferences set by the customer 116 indicate that such communication(s) are to be sent under the circumstances. In other implementations, the monitoring application 126 may additionally or alternatively automatically send an event notification to the customer 116, depending on preferences set by the customer 116, in response to certain data (e.g., feature predictions 214, agent actions 216, cancelation reasons 218, event dispositions 220, etc.) being added to the event table 202. FIG. 7 shows an example customer profile table 700 in which customer preference data of this type may be stored.

As shown in FIG. 7, the customer profile table 700 may include profile data for respective customers 116, e.g., as indexed by customer IDs 702. As illustrated, the customer profile table 700 may include notification preferences 704 for respective customers. The notification preferences 704 may be set by the respective customers.

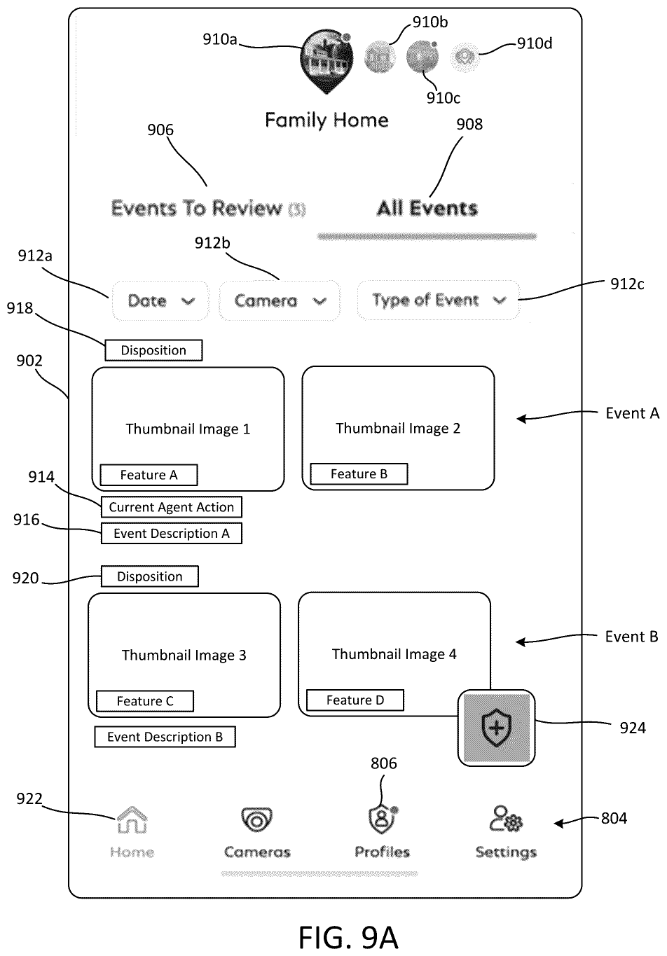

FIGS. 8A-C show example screens 800, 810, and 820 that the customer application 128 may present to a customer 116 to enable the selection of notification preferences. The screens 800, 810 and 820, as well as other customer preference settings described herein, may be accessed, for example, by selecting a “settings” user interface element 802 from a main menu 804 of the customer application 128. As shown in FIG. 8A-C, the customer application 128 may present user interface elements allowing the customer 116 to select one or more particular types of events for which notifications are to be provided (see FIGS. 8A & 8B), as well as one or more particular ways in which such notifications are to be sent (see FIG. 8C). In the illustrated example, the customer application 128 allows the customer 116 to elect to receive (1) notifications about particular types of people, including (A) people matching profiles associated with the customer 116 (e.g., as described further below), (B) service people, such as delivery persons or yard service personnel, and/or (C) unidentified people (e.g., a person visibly on the property who is not identifiable as a service person or a delivery person), and/or (2) notifications about common events, such as animals or pets on the property, nature events such as a tree moving in the wind, etc. Although not shown in FIGS. 8A-C, it should be appreciated that in circumstances in which the customer 116 has multiple properties, different notification preferences may be set for the respective properties. In some implementations, customers may always be sent notifications for events that have been classified as “emergency” or “urgent.” In other implementations, however, customers may be permitted to opt out of receiving even those types of notifications.

Depending on the notification preferences 704 for a customer 116, the monitoring application 126 may cause notifications about events to be sent to the customer in particular circumstances and in particular ways. For instance, if the notification preferences 704 indicate that a customer is to receive “push” notifications about “common events” (e.g., as illustrated in FIG. 8C), then the monitoring application 126 may automatically send a push notification to the customer in response to the entry of a cancelation reason 218 for the event that corresponds to a common event (e.g., “weather event” or “animal or other pet”). As another example, if the notification preferences 704 indicate that a customer is to receive “SMS” notifications about “unidentified persons,” then the monitoring application 126 may send an SMS notification to the customer 116 as specified by a monitoring agent 112 after the monitoring agent 112 has handled the event and/or in response to the entry of a feature prediction 214 and/or an event disposition 220 indicating that an unidentified person is on the property.

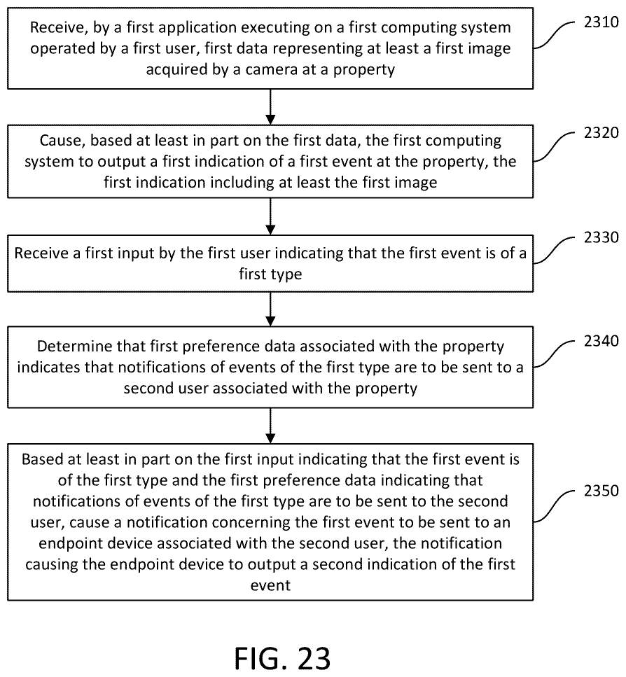

An example process 2300 that may be executed by the monitoring application 126 to send notifications about events to a customer 116 based on the notification preferences 704 for that customer 116 is described below in connection with FIG. 23.

In some implementations, the data in the event table 202 may additionally or alternatively be used to enable the customer application 128 to present information about all detected events (or a selected subset of detected events) associated with a customer 116 and/or particular events that have been flagged for review by the customer 116. FIGS. 9A and 9B show example screens 902 and 904, respectively, that may be presented by a customer application 128 to allow the presentation of such information. In the illustrated example, the screens 902, 904 allow the customer 116 to select either an “events to review” tab 906 or an “all events” tab 908 to toggle between the screens 902 and 904. The screens 902 and 904 may be accessed, for example, by selecting the “home” user interface element 922 from the main menu 804. As shown, in some implementations, the screens 902 and 904 may present a user interface element 924 that can be selected to reveal quick access options to perform operations such as “dispatch police,” “talk to an agent,” or “snooze all cameras.” Further, as also shown in FIGS. 9A and 9B, the screens 902 and 904 may present a “cameras” user interface element 926, which the customer 116 can select to gain access to a live video stream from one or more cameras 102, e.g., as described below in connection with FIG. 17.

Referring first to FIG. 9A, the screen 902 shows example information that may be displayed by the customer application 128 based on data retrieved from the event table 202 when the “all events” tab 908 is selected. As noted above, in some implementations, the customer application 128 may fetch such data from the event table 202, for example, via one or more APIs provided by the monitoring service 106 or another component within the surveillance center environment 1126. In the illustrated example, information for only the two most recent events (labeled “Event A” and “Event B”) is presented. Information about less recent events may be viewed, for example, by scrolling the screen 902 to see the other events. As shown, the screen 902 may include user interface elements 910a, 910b, 910c, and 910d that allow the customer 116 to filter the displayed events based on the property or properties for which event data has been acquired. In the example shown, three properties (corresponding to user interface elements 910a, 910b, 910c) are identified, and the user has selected a “family home” user interface element 910a indicating that event information for only a particular one of the customer's properties (which the customer has designed as the “family home”) is to be presented. The user interface element 910d may, upon selection, reveal the label “all properties” and, in the illustrated example, may be selected to indicate that event data for all three of the customer's properties (corresponding to user interface elements 910a, 910b, and 910c) is to be presented.

As also shown in FIG. 9A, the screen 902 may additionally or alternatively include other user interface elements 912a, 912b and 912c to allow the customer 116 to specify additional filters that are to be applied to the events associated with the customer 116. In particular, the user interface element 912a may allow the customer 116 to filter events by a date or range of dates (e.g., based on the timestamps 206 in the event table 202), the user interface element 912b may allow the customer 116 to filter events by the camera 102 that acquired the image data for the event (e.g., based on the camera IDs 210 in the event table 202), and the user interface element 912c may allow the customer 116 to filter the events by event type (e.g., based on the cancelation reasons 218 and/or the event dispositions 220 in the event table 202). Although not illustrated, it should be appreciated that selection of one of the individual user interface elements 912 may cause a dropdown menu, calendar, etc., to be presented to allow the customer 116 to select an appropriate option.

The identity of the monitored locations 104 that are to be reviewed by a monitoring agent 112, the cameras 102 that are to be made available for such review, and the time periods during which such review is to be performed, among other information, may be stored as monitoring preferences 710 in the customer profile table 700 (shown in FIG. 7.)

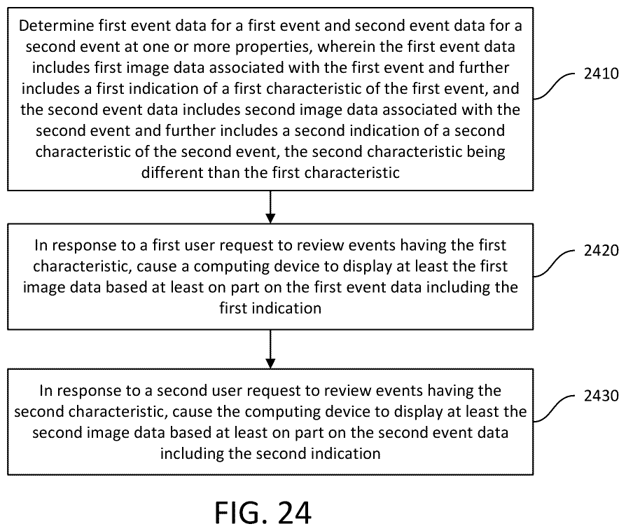

An example process 2400 that may be executed by one or more components of the security system 100 to allow the customer 116 to specify one or more filters that are to be applied to the events presented on the screen 902 is described below in connection with FIG. 24.

In the example illustrated in FIG. 9A, “Event A” represents an event that is currently under review by a monitoring agent 112. In addition to a couple of thumbnail images and corresponding features (e.g., motion detected, person detected, face detected, etc.), information 914 representing the most recent action taken by the monitoring agent 112 may be presented. The information 914 may be derived, for example, based on the most recent agent action 216 that is noted in the event table 202. As shown, the screen may additionally present information 916 describing the event, such as the name of the camera 102 and/or the time at which the event was detected. The information 916 may be derived, for example, based on the camera ID 210 and/or the timestamp 206 for the event in the event table 202. The information 918 may represent the disposition, if any, of the event. The information 918 may be derived, for example, based on the event disposition 220 for the event in the event table 202. As “Event A” is still under review, the disposition indicated by the information 918 may be “under review” or some similar indicator.

For “Event B” in FIG. 9A, similar information is depicted, except for the lack of an indication of the current agent action, as that event is no longer under review by a monitoring agent 112. A disposition indicator 920 for “Event B” may be derived, for example, based on either the cancelation reason 218 in the event table 202 (if the event was canceled) or the event disposition 220 in the event table 202 (if the event was handled by a monitoring agent 112).

Referring next to FIG. 9B, the screen 904 shows example information that may be displayed by the customer application 128 based on data retrieved from the event table 202 when the “events to review” tab 906 is selected. In the illustrated example, the user interface element 910d has been selected to indicated that flagged events from all three of the customer's properties are to be presented for review. Further, in the example, shown, the text associated with the tab 906 indicates that a total of six such events have been flagged for review by the customer 116. As can be seen, the information that is presented for the flagged events may be the same as or similar to the information that is presented for the events under the “all events” tab 908.

Similar to the manner in which event notifications may be sent to customers based on customer-specific preferences, as discussed above, events may be flagged for review by the customer 116 based on preferences that are set by or for the customer. Events may be flagged for review, for example, by writing data to the customer review status 222 of the event table 202 indicating that such events are to be reviewed by the customer 116. As shown in FIG. 7, for example, the customer profile table 700 may include event review preferences 706 that may be used for that purpose. In some implementations, all of the events for which notifications are sent to the customer 116 may also be flagged for review by the customer 116. In such a case, the notification preferences 704 may also serve as the event review preferences 706. In other implementations, the notification preferences 704 and event review preferences 706 may indicate that the circumstances in which notifications are to be sent to the customer 116 are different than the circumstances in which events are to be marked for review by the customer 116. In such implementations, similar to the notification preferences 704, the customer application 128 may present a user interface by which the customer 116 may specify the particular circumstances under which events are to be flagged for review by the customer 116, such that the flagged events appear under the “events to review” tab 906, as shown in FIG. 9B.

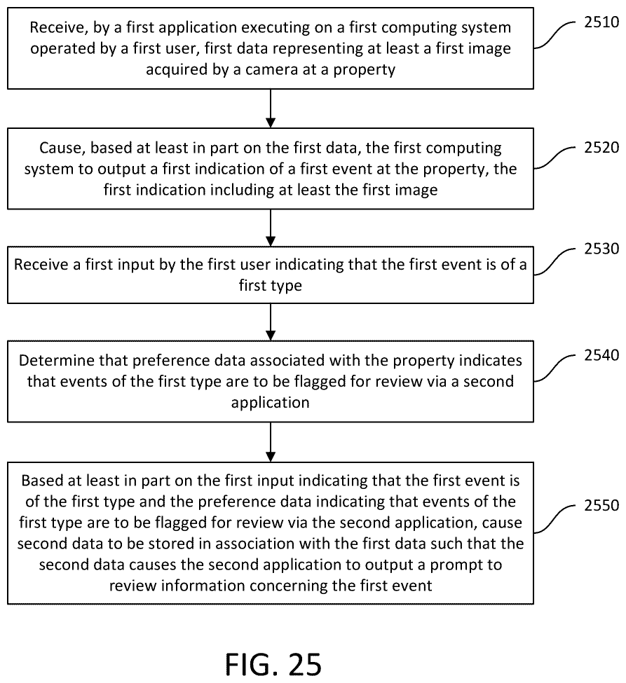

An example process 2500 that may be executed by the monitoring application 126 to flag events for review by a customer 116 based on the event review preferences 706 for that customer 116 is described below in connection with FIG. 25.

In some implementations, events may be flagged for review by a customer 116 after a disposition for the event has been determined by the monitoring agent 112 (as described above). In such a case, the screen 904 would not display the information 914 concerning the most recent action performed by the monitoring agent 112, as depicted in FIG. 9B. In other implementations, all detected events for a customer 116 may be initially flagged for review, such that they appear in under the “events to review” tab 906, but may be unflagged, and thus removed from the screen 904, if and when they are subsequently canceled and/or assigned a disposition by a monitoring agent 112 so that they no longer meet the user-specified criteria for events that are to be flagged for review. Such an implementation would allow the customer to view near real-time actions by a monitoring agent 112 (e.g., via the information 914) under the “events to review” tab 906 as the monitoring agent 112 is reviewing those events. As used herein, the term “near real-time” is used to refer to actions/events that occur within a close temporal proximity (e.g., less than a few seconds) of one another. In such a case, the disposition indicated by the information 918 may be “under review” or some similar indicator until such time as the monitoring agent 112 clears or assigns a disposition to the event.

As shown in FIG. 9B, the customer application 128 may cause the to-be-reviewed events to be accompanied by user interface elements 926 and 928 that allow the customer 116 to either review the event or dismiss the event. In response to selection of the “dismiss event” user interface element 928, the customer application 128 may update the customer review status 222 to indicate that the event is no longer flagged for review, thus causing the information about the event to be removed from the screen 904. In response to selection of the “review” user interface element 926, on the other hand, the customer application 128 may acquire additional information about the event for display on the customer device 114.

FIG. 10A shows an example screen 1002 that the customer application 128 may present on the customer device 114 based on selection of the “review” user interface element 926 shown in FIG. 9B. FIG. 10B shows an example screen 1004 the customer application 128 may present on the customer device 114 based on selection of an “agent response” tab 1006 on the screen 1002 shown in FIG. 10A. The customer application 128 may again cause the customer device 114 to present the screen 1002 in response to selection of the “event timeline” tab 1008 on the screen 1004 shown in FIG. 10B. The same or similar screens may likewise be presented if the customer 116 selects one of the events represented on the “all events” screen 902 shown in FIG. 9A (e.g., by touching or otherwise selecting the region of the screen 902 at which the information about the event is depicted).

As illustrated in FIGS. 10A and 10B, the screens 1002 and 1004 may include event windows 1012, which may be the same as or similar to the event windows 306 described above in connection with FIG. 3, and associated controls 1014 that allow the customer 116 to view recorded video for the event as well as selectively play, rewind and fast-forward that video. Further, the screens 1002 and 1004 may further include timelapse bars 1020, which may be the same as or similar to the timelapse bar 310 described above in connection with FIG. 4, to allow the customer 116 to quickly navigate to and review the portions of the video corresponding to the features identified by the edge image processing component 120 and/or the remote image processing component 122. For example, the customer application 128 may be configured so that selection of one or more of feature indicators 1034 may cause playback of the recorded video to begin in the event window 1012 at or shortly before the time at which the corresponding feature was identified.

As shown in FIG. 10A, when the “event timeline” tab 1008 is selected, the customer application 128 may present thumbnail images 1022 of frames of image data for which the edge image processing component 120 and/or the remote image processing component 122 identified one or more features (e.g., motion, people, faces, etc.) together with feature descriptors 1036 for the features that were so identified and/or time indicators 1038 identifying the times at which such frames were captured. The customer 116 may thus be provided with rich detail concerning the results of the image processing that was performed and the frames that were flagged by that analysis. In some implementations, the customer application 128 may additionally or alternatively be configured such that selection of a thumbnail image 1022, a feature descriptor 1036, and/or a time indicator 1038, may cause playback of the recorded video in the event window 1012 to begin at or shortly before the time at which the corresponding feature was identified.

As shown in FIG. 10A, in some implementations, the customer application 128 may output a prompt 1010 indicating that the customer 116 can provide a particular input, e.g., a long press gesture (sometimes referred to as a “tap and hold” gesture) on a thumbnail image, to create a new profile for a person represented in the thumbnail image and/or provide feedback concerning the image analysis that was performed on that image. In some implementations, the security system 100 may store profiles for various individuals, where such profiles may, for example, include one or more images of the individual as well as data indicating whether or not the individual is authorized to be present at one or more particular monitored locations 104. A customer 116 may create one or more such profiles, for example, by selecting the “profiles” user interface element 806 of the main menu 804. Data representing those profiles may be stored, for example, as visitor profiles 708 in the customer profile table 700 (shown in FIG. 7). In implementations that employ such profiles, the edge image processing component 120 and/or the remote image processing component 122 may use the stored profiles to determine whether a person detected in captured image data is an authorized visitor or instead might be an intruder.

Upon reviewing the screen 1002 (shown in FIG. 10A), the customer 116 may determine, for example, that an individual who was flagged as an unknown person is actually an authorized visitor. Based on such a determination, the customer 116 may perform a “tap and hold,” gesture on the corresponding thumbnail image to create a profile for that individual and thereby inhibit the security system 100 from making the same misidentification in the future. An example of such a gesture (i.e., where a user is providing a tap and hold gesture on a thumbnail image 1022 is illustrated in FIG. 10C. FIG. 10D shows an example screen 1024 that the customer application 128 may present on the customer device 114 in response to detecting such a gesture on thumbnail image (e.g., the thumbnail image 1022). It should be appreciated that, in some implementations, the customer application 128 may likewise present the same or similar screen in response to detecting such a gesture on other thumbnail images it presents, e.g., the thumbnail images presented on the screen 902 shown in FIG. 9A and/or the screen 904 shown in FIG. 9B.

As shown in FIG. 10D, in some implementations, the customer application 128 may cause the customer device 114 to display a face 1026 that was present in the selected thumbnail image (e.g., the thumbnail image 1022 shown in FIG. 10C), and may also provide one or more user interface elements 1028 that the customer 116 can select to identify an existing profile to which the face 1026 is to be added (e.g., by selecting an “add to profile” user interface element 1030) and/or provide a user interface element 1032 that the customer 116 can select to create a new profile (e.g., a profile for new individual) to which the face 1026 is to be added.

Although not illustrated in FIG. 10D, it should be appreciated that, in some implementations, the customer application 128 may additionally or alternatively cause the customer device 114 to present one or more user interface elements that can be selected by the customer 116 to enable the customer 116 to provide feedback concerning that accuracy of the image processing is performed. For example, in a circumstance in which the edge image processing component 120 and/or the remote image processing component 122 identified a person or a face in the thumbnail image (e.g., the thumbnail image 1022), the customer application 128 may cause the customer device 114 to present a “no person” user interface element or a “no face” user interface element on the screen 1024, or on a similar screen, that allows the customer 116 to indicate that the selected thumbnail image (e.g., the thumbnail image 1022) does not, in fact, include a person or does not, in fact, include a face. Such feedback identifying incorrect/inaccurate feature detections may be recorded as customer feedback 224 in the event table 202. In some implementations, such feedback may be subsequently used to retrain the edge image processing component 120 and/or the remote image processing component 122.

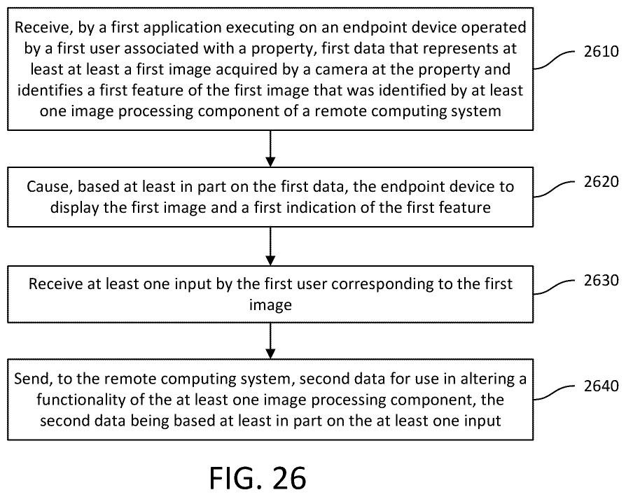

An example process 2600 that may be executed by the customer application 128 to enable a customer 116 to provide feedback for use in altering one of more functionalities of the edge image processing component 120 and/or the remote image processing component 122 is described below in connection with FIG. 26.

As shown in FIG. 10B, when the “agent response” tab 1006 is selected, the customer application 128 may present information 1016 listing actions the monitoring agent 112 took when evaluating the event, and possibly also other events related to the monitoring agent's review, such as the time at which a person was detected by one or more image processing modules, a time that an event notification was loaded into the monitoring agent's review queue, etc. The presented information 1016 relating to the actions taken by the monitoring agent may be derived, for example, from the data representing the agent action(s) 216 in the event table 202.

As also illustrated in FIG. 10B, in some implementations, the customer application 128 may output a prompt 1018 indicating that the customer 116 can provide feedback concerning the manner in which the monitoring agent 112 handled the event. In some implementations, such feedback may be stored as customer feedback 224 in the event table 202 and may be used, for example, for quality control purposes and/or for agent training/re-training.

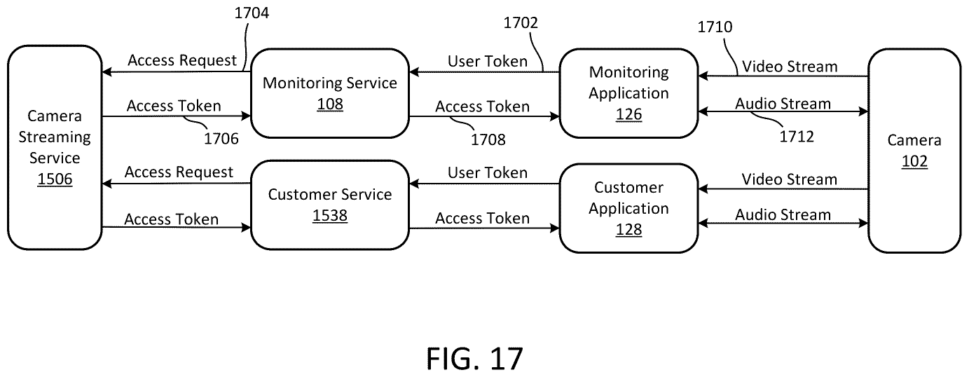

FIG. 11 is a schematic diagram of an example security system 1100 with which various aspects of the present disclosure may be employed. As shown, in some implementations, the security system 1100 may include a plurality of monitored locations 104 (only one of which is illustrated in FIG. 11), a monitoring center environment 1122, a surveillance center environment 1126, one or more customer devices 114, and one or more communication networks 1120. The monitored location 104, the monitoring center environment 1122, the surveillance center environment 1126, the one or more customer device(s) 114, and the communication network(s) 1120 may each include one or more computing devices (e.g., as described below with reference to FIG. 19). The customer device(s) 114 may include one or more customer applications 128, e.g., as applications hosted on or otherwise accessible by the customer device(s) 114. In some implementations, the customer applications 128 may be embodied as web applications that can be accessed via browsers of the customer device(s) 114. The monitoring center environment 1122 may include one or more monitoring applications 126, e.g., as applications hosted on or otherwise accessible to computing devices within the monitoring center environment 1122. In some implementations, the monitoring applications 126 may be embodied as web applications that can be accessed via browsers of computing devices operated by monitoring agents 112 within the monitoring center environment 1122. The surveillance center environment 1126 may include a surveillance service 1130 and one or more transport services 1128.

As shown in FIG. 11, the monitored location 104 may include one or more image capture devices (e.g., cameras 102A and 102B), one or more contact sensor assemblies (e.g., contact sensor assembly 1106), one or more keypads (e.g., keypad 1108), one or more motion sensor assemblies (e.g., motion sensor assembly 1110), a base station 1112, and a router 1114. As illustrated, the base station 1112 may host a surveillance client 1116.

In some implementations, the router 1114 may be a wireless router that is configured to communicate with the devices disposed at the monitored location 104 (e.g., devices 102A, 102B, 1106, 1108, 1110, and 1112) via communications that comport with a communications standard such as any of the various Institute of Electrical and Electronics Engineers (IEEE) 108.11 standards. As illustrated in FIG. 11, the router 1114 may also be configured to communicate with the network(s) 1120. In some implementations, the router 1114 may implement a local area network (LAN) within and proximate to the monitored location 104. In other implementations, other types of networking technologies may additionally or alternatively be used within the monitored location 104. For instance, in some implementations, the base station 1112 may receive and forward communication packets transmitted by one or both of the cameras 102A, 102B via a point-to-point personal area network (PAN) protocol, such as BLUETOOTH. Other suitable wired, wireless, and mesh network technologies and topologies will be apparent with the benefit of this disclosure and are intended to fall within the scope of the examples disclosed herein.

The network(s) 1120 may include one or more public and/or private networks that support, for example, internet protocol (IP) communications. The network(s) 1120 may include, for example, one or more LANs, one or more PANs, and/or one or more wide area networks (WANs). LANs that may be employed include wired or wireless networks that support various LAN standards, such as a version of IEEE 108.11 or the like. PANs that may be employed include wired or wireless networks that support various PAN standards, such as BLUETOOTH, ZIGBEE, or the like. WANs that may be employed include wired or wireless networks that support various WAN standards, such as Code Division Multiple Access (CMDA), Global System for Mobiles (GSM), or the like. Regardless of the particular networking technology that is employed, the network(s) 1120 may connect and enable data communication among the components within the monitored location 104, the monitoring center environment 1122, the surveillance center environment 1126, and the customer device(s) 114. In at least some implementations, both the monitoring center environment 1122 and the surveillance center environment 1126 may include networking components (e.g., similar to the router 1114) that are configured to communicate with the network(s) 1120 and various computing devices within those environments.

The surveillance center environment 1126 may include physical space, communications, cooling, and power infrastructure to support networked operation of a large number of computing devices. For instance, the infrastructure of the surveillance center environment 1126 may include rack space into which the computing devices may be installed, uninterruptible power supplies, cooling plenum and equipment, and networking devices. The surveillance center environment 1126 may be dedicated to the security system 1100, may be a non-dedicated, commercially available cloud computing service (e.g., MICROSOFT AZURE, AMAZON WEB SERVICES, GOOGLE CLOUD, or the like), or may include a hybrid configuration made up of both dedicated and non-dedicated resources. Regardless of its physical or logical configuration, as shown in FIG. 11, the surveillance center environment 1126 may be configured to host the surveillance service 1130 and the transport service(s) 1128.

The monitoring center environment 1122 may include a plurality of computing devices (e.g., desktop computers) and network equipment (e.g., one or more routers) that enable communication between the computing devices and the network(s) 1120. The customer device(s) 114 may each include a personal computing device (e.g., a desktop computer, laptop, tablet, smartphone, or the like) and network equipment (e.g., a router, cellular modem, cellular radio, or the like). As illustrated in FIG. 11, the monitoring center environment 1122 may be configured to host the monitoring application(s) 126 and the customer device(s) 114 may be configured to host the customer application(s) 128.

The devices 102A, 102B, 1106, and 1110 may be configured to acquire analog signals via sensors incorporated into the devices, generate digital sensor data based on the acquired signals, and communicate (e.g., via a wireless link with the router 1114) the sensor data to the base station 1112 and/or one or more components within the surveillance center environment 1126 (e.g., the remote image processing component 122 described above). The types of sensor data generated and communicated by these devices may vary depending on the characteristics of the sensors they include. For instance, the image capture devices or cameras 102A and 102B may acquire ambient light, generate one or more frames of image data based on the acquired light, and communicate the frame(s) to the base station 1112 and/or one or more components within the surveillance center environment 1126, although the pixel resolution and frame rate may vary depending on the capabilities of the devices. In some implementations, the cameras 102A and 102B may also receive and store filter zone configuration data and filter the frame(s) using one or more filter zones (e.g., areas within the FOV of a camera from which image data is to be redacted for various reasons, such as to exclude a tree that is likely to generate a false positive motion detection result on a windy day) prior to communicating the frame(s) to the base station 1112 and/or one or more components within the surveillance center environment 1126. In the example shown in FIG. 11, the camera 102A has a field of view (FOV) that originates proximal to a front door of the monitored location 104 and can acquire images of a walkway 1136, a road 1138, and a space between the monitored location 104 and the road 64A0. The camera 102B, on the other hand, has an FOV that originates proximal to a bathroom of the monitored location 104 and can acquire images of a living room and dining area of the monitored location 104. The camera 102B may further acquire images of outdoor areas beyond the monitored location 104, e.g., through windows 1118A and 1118B on the right-hand side of the monitored location 104.

Individual sensor assemblies deployed at the monitored location 104, e.g., the contact sensor assembly 1106 shown in FIG. 11, may include, for example, a sensor that can detect the presence of a magnetic field generated by a magnet when the magnet is proximal to the sensor. When the magnetic field is present, the contact sensor assembly 1106 may generate Boolean sensor data specifying a closed state of a window, door, etc. When the magnetic field is absent, the contact sensor assembly 1106 may instead generate Boolean sensor data specifying an open state of the window, door, etc. In either case, the contact sensor assembly 1106 shown in FIG. 11 may communicate sensor data indicating whether the front door of the monitored location 104 is open or closed to the base station 1112.

Individual motion sensor assemblies that are deployed at the monitored location 104, e.g., the motion sensor assembly 1110 shown in FIG. 11, may include, for example, a component that can emit high-frequency pressure waves (e.g., ultrasonic waves) and a sensor that can acquire reflections of the emitted waves. When the sensor detects a change in the reflected pressure waves, e.g., because one or more objects are moving within the space monitored by the sensor, the motion sensor assembly 1110 may generate Boolean sensor data specifying an alert state. When the sensor does not detect a change in the reflected pressure waves, e.g., because no objects are moving within the monitored space, the motion sensor assembly 1110 may instead generate Boolean sensor data specifying a still state. In either case, the motion sensor assembly 1110 may communicate the sensor data to the base station 1112. It should be noted that the specific sensing modalities described above are not limiting to the present disclosure. For instance, as but one example of an alternative implementation, the motion sensor assembly 1110 may instead (or additionally) base its operation on the detection of changes in reflected electromagnetic waves.

While particular types of sensors are described above, it should be appreciated that other types of sensors may additionally or alternatively be employed within the monitored location 104 to detect the presence and/or movement of humans, or other conditions of interest, such as smoke, elevated carbon dioxide levels, water accumulation, etc., and to communicate data indicative of such conditions to the base station 1112. For instance, although not illustrated in FIG. 11, in some implementations, one or more sensors may be employed to detect sudden changes in a measured temperature, sudden changes in incident infrared radiation, sudden changes in incident pressure waves (e.g., sound waves), etc. Still further, in some implementations, some such sensors and/or the base station 1112 may additionally or alternatively be configured to identify particular signal profiles indicative of particular conditions, such as sound profiles indicative of breaking glass, footsteps, coughing, etc.

The keypad 1108 shown in FIG. 11 may be configured to interact with a user and interoperate with the other devices disposed in the monitored location 104 in response to such interactions. For instance, in some examples, the keypad 1108 may be configured to receive input from a user that specifies one or more commands and to communicate the specified commands to one or more addressed devices and/or processes, e.g., one or more of the devices disposed in the monitored location 104, the monitoring application(s) 126, and/or the surveillance service 1130. The communicated commands may include, for example, codes that authenticate the user as a resident of the monitored location 104 and/or codes that request activation or deactivation of one or more of the devices disposed in the monitored location 104. In some implementations, the keypad 1108 may include a user interface (e.g., a tactile interface, such as a set of physical buttons or a set of “soft” buttons on a touchscreen) configured to interact with a user (e.g., receive input from and/or render output to the user). Further, in some implementations, the keypad 1108 may receive responses to the communicated commands and render such responses via the user interface as visual or audio output.

The base station 1112 shown in FIG. 11 may be configured to interoperate with other security system devices disposed at the monitored location 104 to provide local command and control and/or store-and-forward functionality via execution of the surveillance client 1116. To implement local command and control functionality, the base station 1112 may execute a variety of programmatic operations through execution of the surveillance client 1116 in response to various events. Examples of such events include reception of commands from the keypad 1108, reception of commands from one of the monitoring application(s) 126 or the customer application 128 via the network(s) 1120, and detection of the occurrence of a scheduled event. The programmatic operations executed by the base station 1112 via execution of the surveillance client 1116 in response to events may include, for example, activation or deactivation of one or more of the devices 102A, 102B, 1106, 1108, and 1110; sounding of an alarm; reporting an event to the surveillance service 1130; and/or communicating “location data” to one or more of the transport service(s) 1128. Such location data may include, for example, data specifying sensor readings (sensor data), image data acquired by one or more cameras 102, configuration data of one or more of the devices disposed at the monitored location 104, commands input and received from a user (e.g., via the keypad 1108 or a customer application 128), or data derived from one or more of the foregoing data types (e.g., filtered sensor data, filtered image data, summarizations of sensor data, event data specifying an event detected at the monitored location 104 via the sensor data, etc.).

In some implementations, to implement store-and-forward functionality, the base station 1112, through execution of the surveillance client 1116, may receive sensor data, package the data for transport, and store the packaged sensor data in local memory for subsequent communication. Such communication of the packaged sensor data may include, for example, transmission of the packaged sensor data as a payload of a message to one or more of the transport service(s) 1128 when a communication link to the transport service(s) 1128 via the network(s) 1120 is operational. In some implementations, such packaging of the sensor data may include filtering the sensor data using one or more filter zones and/or generating one or more summaries (maximum values, average values, changes in values since the previous communication of the same, etc.) of multiple sensor readings.

The transport service(s) 1128 of the surveillance center environment 1126 may be configured to receive messages from monitored locations (e.g., the monitored location 104), parse the messages to extract payloads included therein, and store the payloads and/or data derived from the payloads within one or more data stores hosted in the surveillance center environment 1126. Examples of such data stores are described below in connection with FIG. 19. In some implementations, the transport service(s) 1128 may expose and implement one or more application programming interfaces (APIs) that are configured to receive, process, and respond to calls from base stations (e.g., the base station 1112) via the network(s) 1120. Individual instances of transport service(s) 1128 may be associated with and specific to certain manufactures and/or models of location-based monitoring equipment (e.g., SIMPLISAFE equipment, RING equipment, etc.).

The API(s) of the transport service(s) 1128 may be implemented using a variety of architectural styles and interoperability standards. For instance, in some implementations, one or more such APIs may include a web services interface implemented using a representational state transfer (REST) architectural style. In such implementations, API calls may be encoded using the Hypertext Transfer Protocol (HTTP) along with JavaScript Object Notation (JSON) and/or an extensible markup language. Such API calls may be addressed to one or more uniform resource locators (URLs) corresponding to API endpoints monitored by the transport service(s) 1128. In some implementations, portions of the HTTP communications may be encrypted to increase security. Alternatively (or additionally), in some implementations, one or more APIs of the transport service(s) 1128 may be implemented as a .NET web API that responds to HTTP posts to particular URLs. Alternatively (or additionally), in some implementations, one or more APIs of the transport service(s) 1128 may be implemented using simple file transfer protocol commands. Thus, the API(s) of the transport service(s) 1128 are not limited to any particular implementation.

The surveillance service 1130 within the surveillance center environment 1126 may be configured to control the overall logical setup and operation of the security system 1100. As such, the surveillance service 1130 may communicate and interoperate with the transport service(s) 1128, the monitoring application(s) 126, the customer application(s) 128, and the various devices disposed at the monitored location 104 via the network(s) 1120. In some implementations, the surveillance service 1130 may be configured to monitor data from a variety of sources for events (e.g., a break-in event) and, when an event is detected, notify one or more of the monitoring applications 126 and/or the customer application(s) 128 of the event.

In some implementations, the surveillance service 1130 may additionally be configured to maintain state information regarding the monitored location 104. Such state information may indicate, for example, whether the monitored location 104 is safe or under threat. In some implementations, the surveillance service 1130 may be configured to change the state information to indicate that the monitored location 104 is safe only upon receipt of a communication indicating a clear event (e.g., rather than making such a change solely due to the lack of additional events being detected). This feature can prevent a “crash and smash” robbery (e.g., where an intruder promptly destroys or disables monitoring equipment) from being successfully executed. In addition, in some implementations, the surveillance service 1130 may be configured to monitor one or more particular zones within the monitored location 104, such as one or more particular rooms or other distinct regions within and/or around the monitored location 104 and/or one or more defined regions within the FOVs of the respective image capture devices deployed in the monitored location (e.g., the cameras 102A and 102B shown in FIG. 11).

The individual monitoring application(s) 126 of the monitoring center environment 1122 may be configured to enable monitoring personnel to interact with respective computing devices to provide monitoring services for respective locations (e.g., the monitored location 104), and to execute a variety of programmatic operations in response to such interactions. For example, in some implementations, a monitoring application 126 may control its host computing device to provide information regarding events detected at monitored locations, such as the monitored location 104, to a person operating that computing device. Such events may include, for example, detected movement within a particular zone of the monitored location 104. As described above in connection with FIGS. 3 and 6, in some implementations, the monitoring application 126 may cause a monitoring device 110 to present video of events within individual event windows 306 of a screen 302, and may further establish a streaming connection with one or more cameras 102 at the monitored location and cause the monitoring device 110 to provide streamed video from such camera(s) 102 within the video feed windows 604 and/or a main viewer window 606 of a screen 602, as well as to allow audio communication between the monitoring device 110 and the camera(s) 102.

The customer application(s) 128 of the customer device(s) 114 may be configured to enable customers to interact with their computing devices (e.g., their smartphones or personal computers) to access various services provided by the security system 1100 for their individual homes or other locations (e.g., the monitored location 104), and to execute a variety of programmatic operations in response to such interactions. For example, in some implementations, a customer application 128 may control a customer device 114 (e.g., a smartphone or personal computer) to provide information regarding events detected at monitored locations, such as the monitored location 104, to the customer operating that customer device 114. Such events may include, for example, detected movement within a particular zone of the monitored location 104. In some implementations, the customer application 128 may additionally or alternatively be configured to process input received from the customer to activate or deactivate one or more of the devices disposed within the monitored location 104. Further, as described above in connection with FIG. 6, the customer application 128 may additionally or alternatively be configured to establish a streaming connection with one or more cameras 102 at the monitored location and cause the customer device 114 to display streamed video from such camera(s) 102, as well as to allow audio communication between the customer device 114 and the camera(s) 102.

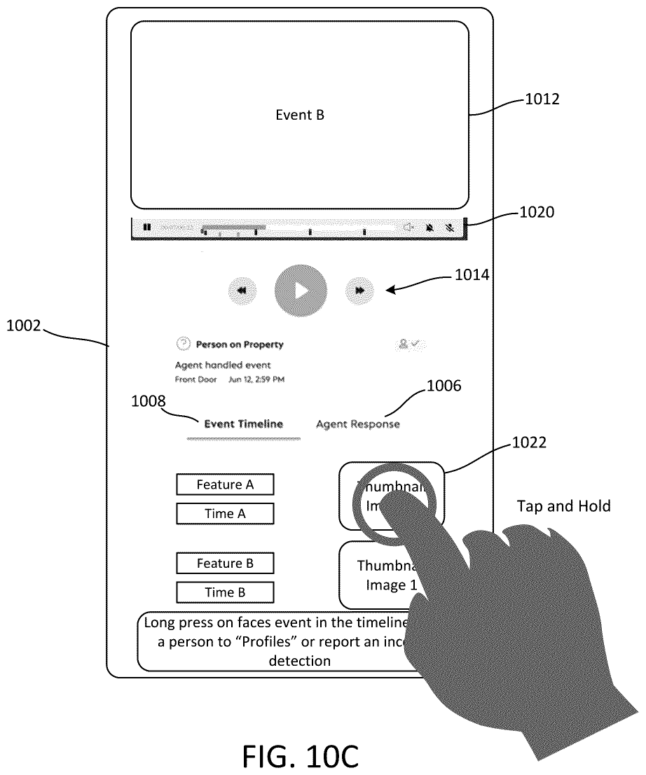

Turning now to FIG. 12, an example base station 1112 is schematically illustrated. As shown in FIG. 12, the base station 1112 may include at least one processor 1202, volatile memory 1204, non-volatile memory 1208, at least one network interface 1206, a user interface 1214, a battery assembly 1216, and an interconnection mechanism 1218. The non-volatile memory 1208 may store executable code 1210 and, as illustrated, may also include a data store 1212. In some implementations, the features of the base station 1112 enumerated above may be incorporated within, or may otherwise be supported by, a housing 1220. In some implementations, the user interface 1214 of the base station 1112 may include only one or more speakers to provide audio output to a user concerning operational state changes of the security system 1100, detected threats, etc., and/or one or more visual indicators (e.g., light emitting diode (LED) indicators) to indicate when the base station 1112 is operational, responding to a user input (e.g., via the keypad 1108), etc. In other implementations, the user interface may additionally or alternatively include a more complex output component (e.g., a display screen) and/or may include one or more user input components, such as one or more microphones (e.g., to receive voice commands) and/or a keypad (e.g., to receive tactile input).

In some implementations, the non-volatile (non-transitory) memory 1208 may include one or more read-only memory (ROM) chips; one or more hard disk drives or other magnetic or optical storage media; one or more solid state drives (SSDs), such as a flash drive or other solid-state storage media; and/or one or more hybrid magnetic and SSDs. In some implementations, the code 1210 stored in the non-volatile memory may include an operating system and one or more applications or programs that are configured to execute under the control of the operating system. In some implementations, the code 1210 may additionally or alternatively include specialized firmware and embedded software that is executable without dependence upon a commercially available operating system. In any event, regardless how the code 1210 is embodied, execution of the code 1210 may implement the surveillance client 1116 shown in FIG. 11 and enable the storage and manipulation of data for the surveillance client 1116 within the data store 1212.

The processor 1202 of the base station 1112 may include one or more processors configured to execute instructions encoded within a computer-readable medium, such as a computer program embodied by the code 1210, to control the operations of the base station 1112. As used herein, the term “processor” describes circuitry that executes a function, an operation, or a sequence of operations. The function, operation, or sequence of operations may be hard coded into the circuitry or soft coded by way of instructions held in a memory device (e.g., the volatile memory 1204) and executed by the circuitry. In some implementations, the processor 1202 may be embodied by one or more application specific integrated circuits (ASICs), microprocessors, digital signal processors (DSPs), graphics processing units (GPUs), neural processing units (NPUs), microcontrollers, field programmable gate arrays (FPGAs), programmable logic arrays (PLAs), and/or multicore processors.

Prior to executing the code 1210, the processor 1202 may copy at least a portion of the code 1210 from the non-volatile memory 1208 to the volatile memory 1204. In some implementations, the volatile memory 1204 may include one or more static or dynamic random access memory (RAM) chips and/or cache memory (e.g., memory disposed on a silicon die of the processor 1202). Volatile memory 1204 may offer a faster response time than a main memory, such as the non-volatile memory 1208.

Through execution of the code 1210, the processor 1202 may control operation of the network interface 1206. For instance, in some implementations, the network interface 1206 may include one or more physical interfaces (e.g., a radio, an ethernet port, a universal serial bus (USB) port, etc.) as well as a software stack including drivers and/or other code 1210 that is configured to communicate with the one or more physical interfaces to support one or more LAN, PAN, and/or WAN standard communication protocols. Such communication protocols may include, for example, transmission control protocol (TCP) and user datagram protocol (UDP) among others. As such, the network interface 1206 may enable the base station 1112 to access and communicate with other computing devices (e.g., the other devices disposed in the monitored location 104 of FIG. 11) via a computer network (e.g., the LAN established by the router 1114 of FIG. 11, the network(s) 1120 of FIG. 11, and/or a point-to-point connection). For instance, in some implementations, the network interface 1206 may utilize sub-GHz wireless networking to transmit wake messages to the other computing devices to request streams of sensor data.

Through execution of the code 1210, the processor 1202 may additionally control operation of hardware and a software stack including drivers and/or other code 1210 that is configured to communicate with other system devices. As such, the base station 1112 may interact with other system components in response to received inputs. Such inputs may specify, for example, values that are to be stored in the data store 1212. The base station 1112 may further provide outputs representing values stored in the data store 1212. In some implementations, the base station 1112 may additionally include one or more light-emitting diodes (LEDs) or other visual indicators to visually communication information, such as system status or alarm events. Further, in some implementations, the base station 1112 may additionally or alternatively include a siren (e.g., a 95 decibel (dB) siren) or other audio output device that may be controlled by the processor 1202 to output an audio indication that a break-in event has been detected.

The various components of the base station 1112 described above may communicate with one another via the interconnection mechanism 1218. In some implementations, the interconnection mechanism 1218 may include a communications bus. Further, in some implementations, the battery assembly 1216 may be configured to supply operational power to the various features of the base station 1112 described above. In some implementations, the battery assembly 1216 may include at least one rechargeable battery (e.g., one or more nickel metal hydride (NiMH) or lithium batteries). In some implementations, such a rechargeable battery (or batteries) may have a runtime capacity sufficient to operate the base station 1112 for twenty-four hours or longer while the base station 1112 is disconnected from or otherwise not receiving line power. In some implementations, the battery assembly 1216 may additionally or alternatively include power supply circuitry to receive, condition, and distribute line power to operate the base station 1112 and/or to recharge one or more rechargeable batteries. Such power supply circuitry may include, for example, a transformer and a rectifier, among other circuitry, to convert AC line power to DC device and/or recharging power.

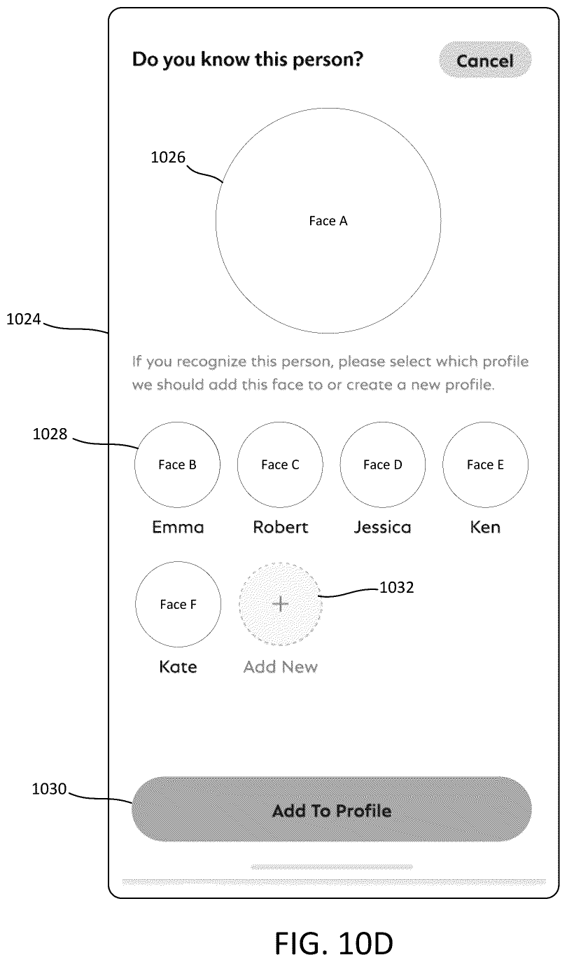

Turning now to FIG. 13, an example keypad 1108 is schematically illustrated. As shown in FIG. 13, the keypad 1108 may include at least one processor 1302, volatile memory 1304, non-volatile memory 1308, at least one network interface 1306, a user interface 1314, a battery assembly 1316, and an interconnection mechanism 1318. The non-volatile memory 1308 may store executable code 1310 and, as illustrated, may also include a data store 1312. In some implementations, the features of the keypad 1108 enumerated above may be incorporated within, or may otherwise be supported by, a housing 1320.

In some implementations, the respective descriptions of the processor 1202, the volatile memory 1204, the non-volatile memory 1208, the interconnection mechanism 1218, and the battery assembly 1216 with reference to the base station 1112 are applicable to the processor 1302, the volatile memory 1304, the non-volatile memory 1308, the interconnection mechanism 1318, and the battery assembly 1316 with reference to the keypad 1108. As such, those descriptions will not be repeated here.

Through execution of the code 1310, the processor 1302 of the keypad 1108 may control operation of the network interface 1306. In some implementations, the network interface 1306 may include one or more physical interfaces (e.g., a radio, an ethernet port, a USB port, etc.) and a software stack including drivers and/or other code 1310 that is configured to communicate with the one or more physical interfaces to support one or more LAN, PAN, and/or WAN standard communication protocols. Such communication protocols may include, for example, TCP and UDP, among others. As such, the network interface 1306 may enable the keypad 1108 to access and communicate with other computing devices (e.g., the other devices disposed in the monitored location 104 of FIG. 11) via a computer network (e.g., the LAN established by the router 1114).

Through execution of the code 1310, the processor 1302 may additionally control operation of the user interface 1314. In some implementations, the user interface 1314 may include user input and/or output devices (e.g., physical keys arranged as a keypad, a touchscreen, a display, a speaker, a camera, a biometric scanner, an environmental sensor, etc.) and a software stack including drivers and/or other code 1310 that is configured to communicate with the user input and/or output devices. As such, the user interface 1314 may enable the keypad 1108 to interact with users to receive inputs and/or render outputs. Examples of outputs that may be rendered by the user interface 1314 include one or more GUIs comprising one or more controls configured to display outputs and/or receive inputs. The inputs received by the user interface 1314 may specify, for example, values that are to be stored in the data store 1312. The outputs provided by the user interface 1314 may further indicate values stored in the data store 1312. In some implementations, parts of the user interface 1314 (e.g., one or more LEDs) may be accessible and/or visible as part of, or through, the housing 1320.

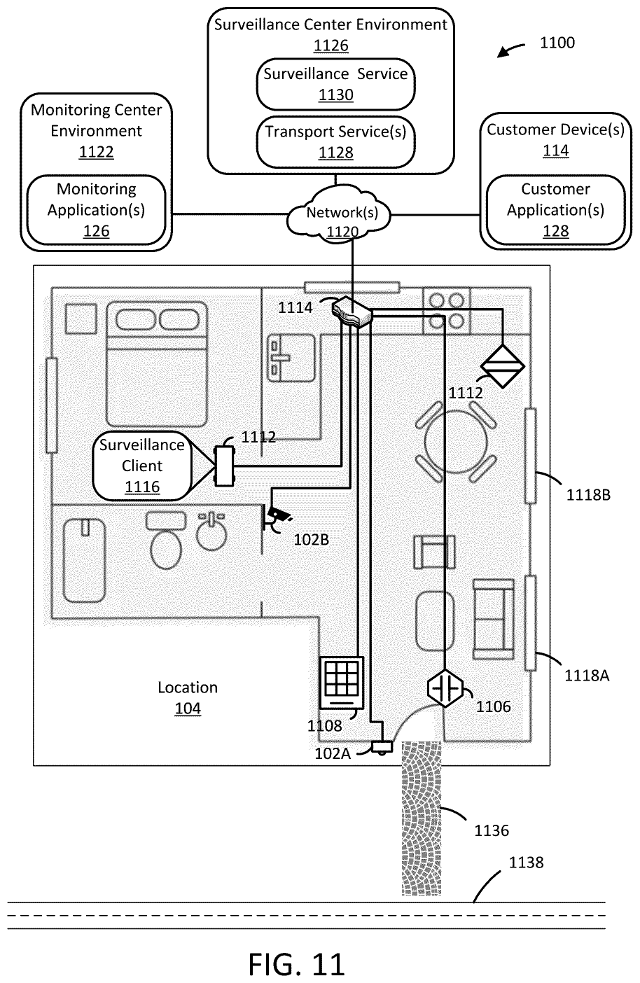

Turning now to FIG. 14, an example sensor assembly 1424 is schematically illustrated. Several example implementations of the sensor assembly 1424 (e.g., the cameras 102 and 102B, the motion sensor assembly 1110, and the contact sensor assemblies 1106) are illustrated in FIG. 11 and described above. As shown in FIG. 14, the sensor assembly 1424 may include at least one processor 1402, volatile memory 1404, non-volatile memory 1408, at least one network interface 1406, a battery assembly 1416, an interconnection mechanism 1418, and at least one sensor 1422. The non-volatile memory 1408 may store executable code 1410 and, as illustrated, may also include a data store 1412. In some implementations, the features of the sensor assembly 1424 enumerated above may be incorporated within, or included as a part of, a housing 1420. Further, in some implementations, the sensor assembly 1424 may additionally include a user interface 1414.

In some implementations, the respective descriptions of the processor 1202, the volatile memory 1204, the non-volatile memory 1208, the interconnection mechanism 1218, and the battery assembly 1216 with reference to the base station 1112 are applicable to the processor 1402, the volatile memory 1404, the non-volatile memory 1408, the interconnection mechanism 1418, and the battery assembly 1416 with reference to the sensor assembly 1424. As such, those descriptions will not be repeated here.

Through execution of the code 1410, the processor 1402 may control operation of the network interface 1406 and the user interface 1414 (if present). In some implementations, the network interface 1406 may include one or more physical interfaces (e.g., a radio, an ethernet port, a USB port, etc.) and a software stack including drivers and/or other code 1410 that is configured to communicate with the one or more physical interfaces to support one or more LAN, PAN, and/or WAN standard communication protocols. Such communication protocols may include, for example, TCP and UDP, among others. As such, the network interface 1406 may enable the sensor assembly 1424 to access and communicate with other computing devices (e.g., the other devices disposed in the monitored location 104 of FIG. 11) via a computer network (e.g., the LAN established by the router 1114). For instance, in some implementations, when executing the code 1410, the processor 1402 may control the network interface to stream (e.g., via UDP) sensor data acquired from the sensor assembly 1422 to the base station 1112. Further, in some implementations, through execution of the code 1410, the processor 1402 may additionally or alternatively control the network interface 1406 to enter a power conservation mode, e.g., by powering down a 2.4 GHz radio and powering up a sub-GHz radio that are both included in the network interface 1406. In such implementations, through execution of the code 1410, the processor 1402 may additionally control the network interface 1406 to enter a streaming mode, e.g., by powering up a 2.4 GHz radio and powering down a sub-GHz radio, for example, in response to receiving a wake signal from the base station via the sub-GHz radio.

Through execution of the code 1410, the processor 1402 may additionally or alternatively control other operations of the sensor assembly 1424. In some implementations, for example, a user interface 1414 of the sensor assembly 1424 may include user input and/or output devices (e.g., physical buttons, a touchscreen, a display, a speaker, a camera, an accelerometer, a biometric scanner, an environmental sensor, one or more LEDs, etc.) and a software stack including drivers and/or other code 1410 that is configured to communicate with the user input and/or output devices. As such, the sensor assembly 1424 may enable the user interface 1414 to interact with users to receive inputs and/or render outputs. The outputs rendered by the user interface 1314 may include, for example, one or more GUIs including one or more controls configured to display output and/or receive input. The inputs received by the user interface 1414 may, for example, specify values that are to be stored in the data store 1412. The outputs provided by the user interface 94 may further indicate values stored in the data store 1412. In some implementations, parts of sensor assembly 1424 may be accessible and/or visible as part of, or through, the housing 1420.

As shown in FIG. 14, the sensor assembly 1424 may include one or more types of sensors 1422, such as one or more of the sensors described above with reference to the cameras 102A and 102B, the motion sensor assembly 1110, and the contact sensor assembly 1106 of FIG. 11, or other types of sensors. In some implementations, for example, the sensor(s) 1422 may include a camera and a temperature sensor. Regardless of the type(s) of sensor(s) XD22 that employed, the processor 1402 may (e.g., via execution of the code 1410) acquire sensor data from the sensor(s) 1422 and stream the acquired sensor data to the processor 1402 for communication to the base station 1112.

It should be noted that, in some implementations of the devices 1302 and 1402, the operations executed by the processors 1302 and 1402 while under control of respective control of the code 1310 and 1410 may be hardcoded and/or implemented using hardware, rather than as a combination of hardware and software.

Turning now to FIG. 15, aspects of the surveillance center environment 1126, the monitoring center environment 1122, one of the customer devices 114, the network(s) 1120, and a plurality of monitored locations 104A through 104N (collectively referred to as the monitored locations 104) shown in FIG. 11 are schematically illustrated. As shown in FIG. 15, in some implementations, the surveillance service 1130 may include a location data store 1502, an image data store 1504, an artificial intelligence (AI) service 1508, an event listening service 1510, an identity provider service 1512, a customer service 1538, a monitoring service 106, and a camera streaming service 1506. As also shown in FIG. 15, the monitoring center environment 1122 may include multiple monitoring devices 110A through 110M (collectively referred to as the monitoring devices 110) that host or are otherwise configured to access respective monitoring applications 126A through 126M, and individual monitored locations 104A through 104N may include respective surveillance clients 1116A through 1116N (collectively referred to as the surveillance clients 1116), e.g., within base stations 1112 (not shown in FIG. 15) at the various monitored locations 104A through 1102N. As described above in connection with FIGS. 3 and 6, in some implementations, the monitoring applications 126 may be configured to cause the monitoring devices 110 to display screens 302, 602 that enable a monitoring agent 112 to visually monitor activity one or more of the monitored locations 104, as well as engage in an audio dialog with one or more individuals at such locations (e.g., via microphones and speakers of cameras 102 at the monitored locations 104). Further, as additionally shown in FIG. 15, in some implementations, the transport service(s) 1128 may include multiple different transport services 1128A through 1128D configured to receive location data packages, e.g., location data packages 1014A through 1014D, from the surveillance clients 1116A through 616N deployed at the respective monitored locations 104A through 1102N.

The location data store 1502 of the surveillance service 1130 may be configured to store, within a plurality of records, location data in association with identifiers of customers for whom the monitored location 104 is monitored. For example, the location data may be stored in a record with an identifier of a customer and/or an identifier of the monitored location 104 to associate the location data with the customer and the monitored location 104. The image data store 1504 of the surveillance service 1130 may be configured to store, within a plurality of records, one or more frames of image data in association with identifiers of locations and timestamps at which the image data was acquired.

The AI service 1508 of the surveillance service 1130 may be configured to process images and/or sequences of images to identify semantic regions, movement, human faces, and other features within images or a sequence of images. The event listening service 1510 of the surveillance service 1130 may be configured to scan received location data for events and, where an event is identified, execute one or more event handlers to process the event. In some implementations, such event handlers may be configured to identify events and to communicate messages concerning those events to one or more recipient services (e.g., the customer service 1538 and/or the monitoring service 106). Operations that may be performed by the customer service 1538 and/or the monitoring service 106 based on the events identified by the event listening service 1510 are described further below. In some implementations, the event listening service 1510 may interoperate with the AI service 1508 to identify events within image data.

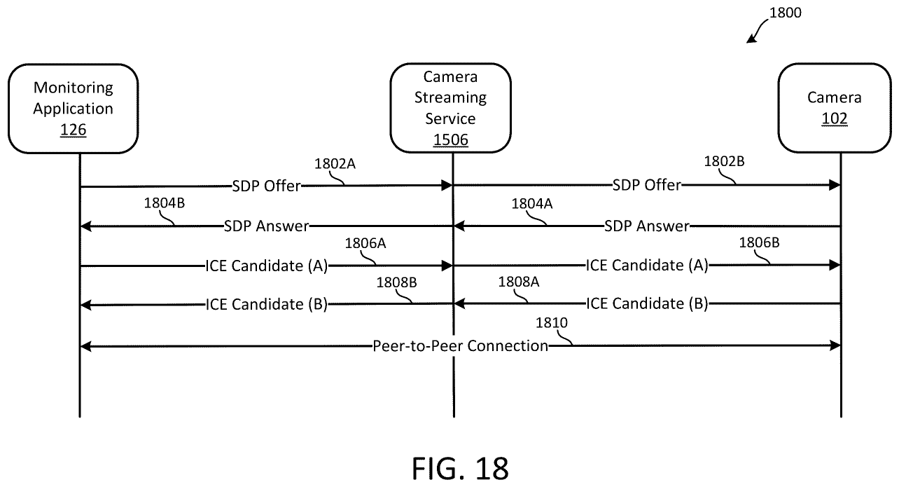

The identity provider service 1512 may be configured to receive authentication requests from the surveillance clients 1116 that include security credentials. When the identity provider 1512 can authenticate the security credentials in a request (e.g., via a validation function, cross-reference look-up, or some other authentication process), the identity provider 1512 may communicate a security token in response to the request. A surveillance client 1116 may receive, store, and include the security token in subsequent packages of location data (e.g., the location data 1014A), so that the recipient transport service (e.g., the transport service 1128A) is able to securely process (e.g., unpack/parse) the packages to extract the location data prior to passing the location data to the surveillance service 1130. In some implementations, for example, the security token may be a JSON Web Token (JWT)), such as the token 2002 that is described below in connection with FIG. 20.

The transport service(s) 1128 of the surveillance center environment 1126 may be configured to receive the location data packages 1514, verify the authenticity of the packages 1514, parse the packages 1514, and extract the location data encoded therein prior to passing the location data to the surveillance service 1130 for processing. The location data that is so processed may include any of the location data types described above with reference to FIG. 11. In some implementations, individual transport services 1128 may be configured to process location data packages 1514 generated by location-based monitoring equipment of particular manufacturers and/or models. The surveillance clients 1116 may be configured to generate and communicate, e.g., to the surveillance service 1130 via the network(s) 1120, packages of location data (e.g., the location data packages 1514) based on sensor information received at the monitored locations 104.

The monitoring service 106 may maintain records concerning the events identified by the event listening service 1510 and may assign individual events to various monitoring agents 112 who are currently on-line with monitoring applications 126. The monitoring application 126 operated by a given monitoring agent 112 may then add the events assigned to that monitoring agent 112 to a queue of events, e.g., within the event windows 306 shown in FIG. 1A, for review by that monitoring agent 112. In some implementations, a given monitoring application 126 may use data describing the events within its queue to retrieve location data and/or image data (from the location data store 1502 and/or the image data store 1504, respectively) for presentation within or in association with the event windows 306.

In response to the monitoring agent 112 identifying a particular event to review (e.g., by clicking on one of the event windows 306), the monitoring service 106 may interact with the camera streaming service 1506 to obtain access credentials to enable the establishment of peer-to-peer connections with one or more cameras 102 at the monitored location 104 corresponding to the event, and to review live video and/or audio streamed from those cameras, e.g., within the video feed windows 604 and/or the main viewer window 606 shown in FIG. 6, as well as to verbally communicate in real time with one or more individuals in the vicinity of the camera(s) 102. Example interactions amongst components of the security system 1100 to enable the streaming of video and/or audio data between the camera(s) 102 at the monitored location 104 and the monitoring application 126 operated by the monitoring agent 112 are described below in connection with FIGS. 17 and 18.

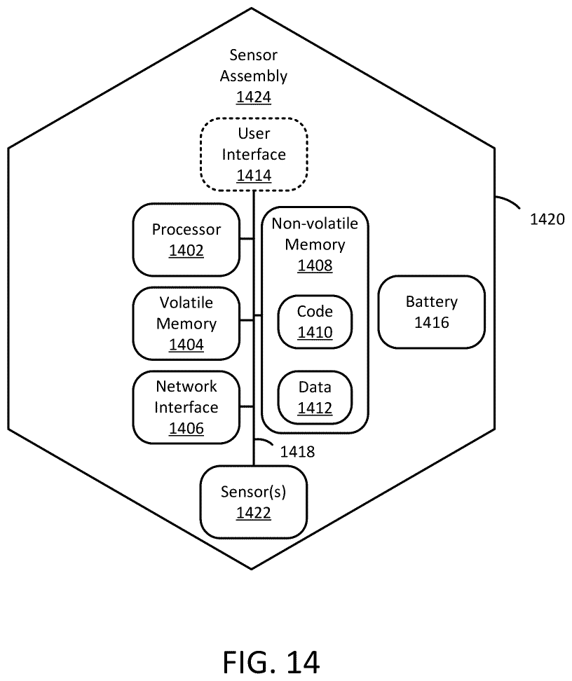

Turning now to FIG. 16, an example monitoring process 1600 that may be employed by the security system 1100 is illustrated as a sequence diagram. In particular, in some implementations, various portions of the process 1600 may be executed by (A) one or more location-based devices (e.g., the devices 102A, 102B, 1106, 1108, and 1114 of FIG. 11) under the control of device control system (DCS) code (e.g., either the code 1310 or 1410) implemented by at least one processor (e.g., either of the processors 1302 or 1402 of FIG. 13 or 14); (B) a base station (e.g., the base station 1112 of FIG. 11) under control of a surveillance client (e.g., the surveillance client 1116 of FIG. 11); (C) a monitoring center environment (e.g., the monitoring center environment 1122 of FIG. 11) under control of a monitoring application (e.g., the monitoring application 126 of FIG. 11); (D) a surveillance center environment (e.g., the surveillance center environment 1126 of FIG. 11) under control of a surveillance service (e.g., the surveillance service 1130 of FIG. 11); and (E) a customer device (e.g., the customer device 114 of FIG. 11) under control of a customer application (e.g., customer application 128 of FIG. 11).

As shown in FIG. 16, the process 1600 may begin with the surveillance client 1116 authenticating with the surveillance service 1130 by exchanging one or more authentication requests and responses 1604 with the surveillance service 1130. More specifically, in some implementations, the surveillance client 1116 may communicate an authentication request to the surveillance service 1130 via one or more API calls to the surveillance service 1130. In such implementations, the surveillance service 1130 may parse the authentication request to extract security credentials therefrom and pass such security credentials to an identity provider (e.g., the identity provider service 1512 of FIG. 15) for authentication. In some implementations, upon the identity provider authenticating the security credentials, the surveillance service 1130 may generate a security token and communicate that security token as a payload within an authentication response to the authentication request. In such implementations, if the identity provider is unable to authenticate the security credentials, the surveillance service 1130 may instead generate an error (e.g., an error code) and communicate that error as the payload within the authentication response to the authentication request. Upon receipt of the authentication response, the surveillance client 1116 may parse the authentication response to extract the payload. If the payload includes the error code, the surveillance client 1116 may retry authentication and/or interoperate with a user interface of its host device (e.g., the user interface 1214 of the base station 1112 of FIG. 12) to render output indicating the authentication failure. If the payload includes the security token, the surveillance client 1116 may store the security token for subsequent use in communication of location data. It should be noted that, in some implementations, the security token may have a limited lifespan (e.g., one hour, one day, one week, one month, etc.) after which the surveillance client 1116 may be required to reauthenticate with the surveillance service 1130. In some implementations, for example, the lifespan of the security token (e.g., a token 2002 of the type described below in connection with FIG. 20) may be defined within the header 2004 and/or the payload 2006 of the token 2002 (e.g., as one or more claims).

Continuing with the process 1600, one or more device control systems 1602 hosted by one or more location-based devices may acquire (1606) sensor data descriptive of a location (e.g., the monitored location 104 of FIG. 11). The sensor data that is so acquired may be any of a variety of types, as discussed above with reference to FIGS. 11-15. In some implementations, one or more of the device control systems 1602 may acquire sensor data continuously. In other implementations, one or more of the DCSs 1602 may additionally or alternatively acquire sensor data in response to an event, such as expiration of a timer (a push event) or receipt of an acquisition polling signal communicated by the surveillance client 1116 (a poll event). In some implementations, one or more of the device control systems 1602 may stream sensor data to the surveillance client 1116 with minimal processing beyond acquisition and digitization. In such implementations, the sensor data may constitute a sequence of vectors with individual vector members including, for example, a sensor reading and a timestamp. In some implementations, one or more of the device control systems 1602 may execute additional processing of sensor data, such as generation of one or more summaries of multiple sensor readings. Further still, in some implementations, one or more of the device control systems 1602 may execute sophisticated processing of sensor data. For example, if the sensor(s) 1422 of a sensor assembly 1424 (shown in FIG. 14) include an image capture device, the device control system 1602 may execute image processing routines such as edge detection, motion detection, facial recognition, threat assessment, event generation, etc.

Continuing with the process 1600, the device control component(s) 1602 may communicate the sensor data 1608 to the surveillance client 1116. As with sensor data acquisition, the device control system(s) 1602 may communicate the sensor data 1608 continuously or in response to an event, such a push event (originating with the device control system(s) 1602) or a poll event (originating with the surveillance client 1116).

Continuing with the process 1600, the surveillance client 1116 may monitor (1610) the monitored location 104 by processing the received sensor data 1608. In some implementations, for example, the surveillance client 1116 may execute one or more image processing routines. Such image processing routines may include any of the image processing routines described above with reference to the operation 1606. By distributing at least some of the image processing routines between the device control system(s) 1602 and surveillance client 1116, the amount of power consumed by battery-powered devices may be decreased by off-loading processing to line-powered devices. Moreover, in some implementations, the surveillance client 1116 may execute an ensemble threat detection process that utilizes sensor data 1608 from multiple, distinct device control systems 1602 as input. For instance, in some implementations, the surveillance client 1116 may attempt to corroborate an open state received from a contact sensor with motion and facial recognition processing of an image of a scene including a window or door to which the contact sensor is affixed. If two or more of the three processes indicate the presence of an intruder, a score (e.g., a threat score) may be increased and or a break-in event may be declared, locally recorded, and communicated. Other processing that the surveillance client 1116 may execute includes outputting local alerts (e.g., in response to detection of particular events and/or satisfaction of other criteria) and detection of maintenance conditions for location-based devices, such as a need to change or recharge low batteries and/or replace/maintain the devices that host the device control system(s) 1602. Any of the processes described above within the operation 1610 may result in the creation of location data that specifies the results of such processes.

Continuing with the process 1600, the surveillance client 1116 may communicate the location data 1612 to the surveillance service 1130 (via the transport service(s) 1128). As with the communication of the sensor data 1608, the surveillance client 1116 may communicate the location data 1612 continuously or in response to an event, such as a push event (originating with the surveillance client 1116) or a poll event (originating with the surveillance service 1130).

Continuing with the process 1600, the surveillance service 1130 may process (1614) the received location data. In some implementations, for example, the surveillance service 1130 may execute one or more of the processes described above with reference to the operations 1606 and/or 1610. In some implementations, the surveillance service 1130 may additionally or alternatively calculate a score (e.g., a threat score) or further refine an existing score using historical information associated with the monitored location 104 identified in the location data and/or other locations geographically proximal to the monitored location 104 (e.g., within the same zone improvement plan (ZIP) code). For instance, in some implementations, if multiple break-ins have been recorded for the monitored location 104 and/or other locations within the same ZIP code, the surveillance service 1130 may increase a score calculated by a device control system 1602 and/or the surveillance client 1116.

In some implementations, the surveillance service 1130 may apply a set of rules and criteria to the location data 1612 to determine whether the location data 1612 includes any events and, if so, communicate an event report 1616A and/or 1616B to the monitoring application 126 and/or the customer application 128. In some implementations, for example, the monitoring service 106 may assign one or more events to a particular monitoring agent 112, so that those events will be forwarded to the monitoring application 126 that the monitoring agent 112 is operating, e.g., for presentation within respective event windows 306 (shown in FIG. 3). An event may, for example, be an event of a certain type (e.g., break-in) or an event of a certain type that satisfies additional criteria (e.g., movement within a particular zone combined with a threat score that exceeds a threshold value). The event reports 1616A and/or 1616B may have a priority based on the same criteria used to determine whether the event reported therein is reportable or may have a priority based on a different set of criteria or rules.

Continuing with the process 1600, the monitoring application 126 within the monitoring center environment 1122 may interact (1618) with monitoring agents 112 through, for example, one or more GUIs, such as the screens 302 and 602 shown in FIGS. 3 and 6. Such GUIs may provide details and context regarding one or more events.

As shown in FIG. 16, the customer application 128 of a customer device 114 (e.g., a smartphone, personal computer, or other endpoint device) may likewise interact (1620) with at least one customer through, for example, one or more GUIs. Such GUIs may provide details and context regarding one or more events.

It should be noted that the processing of sensor data and/or location data, as described above with reference to the operations 1606, 1610, and 1614, may be executed by processors disposed within various parts of the security system 1100. In some implementations, the device control system(s) 1602 may execute minimal processing of the sensor data (e.g., acquisition and streaming only) and the remainder of the processing described above may be executed by the surveillance client 1116 and/or the surveillance service 1130. This approach may be helpful to prolong battery runtime of location-based devices. In other implementations, the device control system(s) 1602 may execute as much of the sensor data processing as possible, leaving the surveillance client 1116 and the surveillance service 1130 to execute only processes that require sensor data that spans location-based devices and/or locations. Such an approach may be helpful to increase scalability of the security system 1100 with regard to adding new locations.

FIGS. 17 and 18 illustrate an example technique for establishing point-to-point connections (e.g., for video and/or audio streaming) between a camera 102 at a monitored location 104 and either or both of (A) a monitoring application 126 hosted on or otherwise accessible by a monitoring device 110, and (B) a customer application 128 hosted on or otherwise accessible by a customer device 114. In some implementations, the monitoring application 126 and the customer application 128 may be web applications that are accessed using browsers hosted on the monitoring device 110 and the customer device 114, respectively, and the WebRTC functionality of those browsers may be used to establish peer-to-peer connections with the camera 102. As described below in connection with FIG. 18, the camera streaming service 1506 may provide signaling channels that are used establish peer-to-peer connections between the camera 102 and the respective browsers. As one example, the camera streaming service 1506 may be implemented using the Amazon Kinesis Video Streams service offered by Amazon Web Services (AWS).

As indicated by an arrow 1702 in FIG. 17, the monitoring application 126 may provide a user token to the monitoring service 106. The user token may correspond to the monitoring agent 112 who has authenticated to monitoring application 126 and may be included in a request for live-streaming access to the camera(s) 102 at a monitored location 104. In some implementations, for example, such a camera access request may be sent from the monitoring application 126 to the monitoring service 106 in response to a monitoring agent 112 selecting an event window 306 corresponding to a particular camera 102 as described above in connection with FIG. 3. In some implementations, the user token may be a JWT, such as the token 2002 that is described below in connection with FIG. 20.

The monitoring service 106 may evaluate the user token received from the monitoring application 126 (e.g., by validating a signature 2008 of the token as described below in connection with FIG. 20) and, if valid, may communicate with the camera streaming service 1506 to obtain an access token that the monitoring application 126 may subsequently use to access a signaling channel of the camera streaming service 1506. An example process by which signaling information may be exchanged between the monitoring application 126 and the camera 102, via a signaling channel established by the camera streaming service 1506, to determine configuration information for a peer-to-peer connection between the monitoring application 126 and the camera 102 is described below in connection with FIG. 18. In some implementations, the access token obtained from the camera streaming service 1506 may be a JWT, such as the token 2002 that is described below in connection with FIG. 20.

As indicated by an arrow 1704 in FIG. 17, in some implementations, the monitoring service 106 may authenticate to the camera streaming service 1506 and request access to the camera streaming service 1506 on behalf of the monitoring application 126 that provided the user token (per the arrow 1702). In some implementations, the access request the monitoring service 106 sends to the camera streaming service 1506 may specify one or more parameters that identify the specific monitored location 104 at issue, the specific camera(s) 102 to which access is to be granted, a specific time window during which access to such cameras 102 is to be granted, and/or other any of a number of other limitations or restrictions concerning whether and/or how access to the camera(s) 102 is to be permitted. The use of such parameters can help ensure that the camera(s) 102 are accessed only by authorized personnel and only as needed to evaluate a specific event.

Upon authenticating the access request received from the monitoring service 106, the camera streaming service 1506 may establish a signaling channel between the monitoring application 126 and the camera 102, and generate an access token (e.g., a token 2002 of the type described below in connection with FIG. 20) that the monitoring application 126 can subsequently use to access that signaling channel (e.g., by making Web API calls to an API endpoint of the camera streaming service 1506). In some implementations, the monitoring service 106 may configure the access token to include one or more of the parameters that were specified in the access request. For example, in some implementations, such parameters may be defined within a header 2004 and/or a payload 2006 of the access token (e.g., as one or more claims).

As indicated by arrows 1706 and 1708 in FIG. 17, the camera streaming service 1506 may send the generated access token to the monitoring service 106, and the monitoring service 106 may then pass that access token to the monitoring application 126. In some implementations, the camera streaming service 1506 may also send additional information along with the access token, such as a network address (e.g., a Web API endpoint) for the signaling channel established by the camera streaming service 1506, thus allowing the monitoring application 126 to make Web API calls to the camera streaming service 1506 for signaling purposes. As noted previously, the access token generated by the camera streaming service 1506 may be configured based on the parameters that were included in the access request the monitoring service 106 sent to the camera streaming service 1506, so as to limit the ability of the recipient monitoring application 126 to access the established signaling channel in the manner defined by those parameters. For example, the access token generated by the camera streaming service 1506 may be set to expire after a particular time period based on a time limit parameter that was included in the access request.

As described below in connection with FIG. 18, upon receipt of the access token from the monitoring service 106, the monitoring application 126 may send a session description protocol (SDP) offer to a network address of the signaling channel and the signaling channel may forward that SDP offer to the camera 102, thus initiating the signaling process to establish a peer-to-peer connection between the monitoring application 126 and the identified camera 102. Finally, as also described below in connection with FIG. 18, as indicated by arrows 1710 and 1712 in FIG. 17, upon identifying suitable interactive connectivity establishment (ICE) candidates, one or more peer-to-peer connections may be established between the monitoring application 126 and the camera 102, thus enabling the streaming of video data from the camera 102 to the monitoring application 126 and/or the exchange of audio data between the monitoring application 126 and the camera 102.

A similar process may be employed to establish one or more peer-to-peer connections between the customer application 128 and one or more camera(s) 102 at the monitored location, thus enabling the streaming of video data from the camera(s) 102 to the customer application 128 and/or the exchange of audio data between the customer application 128 and the camera(s) 102. That process will thus not be described again here. It should be appreciated, however, that the scope of the permissions provided in the access requests that are sent from the customer service 1538 to the camera streaming service 1506 may be different (e.g., less restrictive) than the scope of the permissions provided by access requests that are sent from the monitoring service 106 to the camera streaming service 1506, as it may not be desirable to restrict a customer's ability to live stream with the camera in the same manner as the monitoring agents 112.

FIG. 18 is a sequence diagram 1800 illustrating how signaling information (e.g., WebRTC signaling information) can be exchanged between the monitoring application 126 (or alternatively the customer application 128) and a camera 102, via the camera streaming service 1506, to establish a peer-to-peer connection between the monitoring application 126 (or alternatively the customer application 128) and the camera 102. Although FIG. 18 depicts the exchange of signaling information between the monitoring application 126 and the camera 102, and the following section describes the exchange of signaling information between those two components, it should be appreciated that the same process may likewise be used to exchange signaling information between the customer application 128 and the camera 102.

As noted above, in some implementations, the monitoring application 126 may have received an access token for the camera streaming service 1506 from the monitoring service 106 (see the arrow 1708 in FIG. 17) in response to providing a user token to the monitoring service 106 (see the arrow 1702 in FIG. 17), and such access token may enable the monitoring application 126 to access a signaling channel established by the camera streaming service 1506, thus allowing the monitoring application 126 to make Web API calls to the camera streaming service 1506 for signaling purposes.

As shown in FIG. 18, the signaling process may begin with the monitoring application 126 using the received access token to send (1802A, 1802B) an SDP offer to the camera 102 (via the camera streaming service 1506). The monitoring application 126 may create the SDP offer, for example, by calling the CreateOffer( ) function of the WebRTC application programing interface (API) of a browser or other WebRTC-enabled component of the monitoring device 110. The SDP offer may include information about the kind of media that is to be sent by the monitoring device 110, its format, the transfer protocol being used, the internet protocol (IP) address and port of the monitoring device 110, and/or other information needed to describe the to-be-transferred media and/or the monitoring device 110.

Upon receiving the SDP offer from the monitoring application 126, the camera 102 may send (1804A, 1804B) an SDP answer to the monitoring application 126 via the camera streaming service 1506. The camera 102 may create the SDP answer, for example, by calling the CreateAnswer( ) function of the WebRTC API of a browser or other WebRTC-enabled component of the camera 102. The SDP answer may include information about the kind of media that is to be sent by the camera 102, its format, the transfer protocol being used, the internet protocol (IP) address and port of the camera 102, and/or other information needed to describe the to-be-transferred media and/or the camera 102.

In addition to sharing information about the media that is to be exchanged and the respective devices that will be exchanging it, the monitoring application 126 and the camera 102 may share information about the network connections they are able to use to exchange that media. In particular, the monitoring application 126 may share one or more ICE candidates with the camera 102, and vice versa, with the individual ICE candidates sent by a device describing the available methods that device is able to use to communicate (either directly or through a traversal using relays around NAT (TURN) server). The monitoring application 126 and the camera 102 may gather ICE candidates, for example, by creating an ICE candidate event listener using the WebRTC API (e.g., by calling the function peerConnection.addEventListener(‘icecandidate’, event=>{ . . . }).

In some implementations, the respective devices may propose their best ICE candidates first, making their way down the line toward their worse candidates. Ideally, ICE candidates employ the user data protocol (UDP) (since it's faster, and media streams are able to recover from interruptions relatively easily), but the ICE standard does allow transmission control protocol (TCP) candidates as well.

Possible UDP candidate types include host, peer reflexive (prflx), server reflexive (srflx), and relay. A “host” candidate is one for which its IP address is the actual, direct IP address of the remote peer. A “peer reflexive” candidate is one whose IP address comes from a symmetric network address translation (NAT) between the two peers. A “server reflexive” candidate is generated by a session traversal of UDP through NAT (STUN) server. A relay candidate is generated by a TURN server. Possible TCP candidate types include active, passive, and so. An “active” transport will try to open an outbound connection but won't receive incoming connection requests. A “passive” transport will receive incoming connection attempts but won't attempt a connection itself. A “so” transport will try to simultaneously open a connection with its peer.

As an example, FIG. 18 illustrates how the monitoring application 126 may send (1806A, 1806B) ICE candidate “A” to the camera 102, and the camera 102 may send (1808A, 1808B) ICE candidate “B” to the monitoring application 126. Different pairs of the identified ICE candidates may be tested and one of the endpoints which has been designated as the “controlling agent” may select one of the identified ICE candidate pairs to use to establish (1810) a peer-to-peer connection between the monitoring application 126 and the camera 102.

Additional information concerning the use of WebRTC to establish peer-to-peer connections can be found on the web pages accessible via the uniform resource locator (URL) “webrtc.org,” the entire contents of which are hereby incorporated herein by reference.

Turning now to FIG. 19, a computing device 1900 is illustrated schematically. As shown in FIG. 19, the computing device 1900 may include at least one processor 1902, volatile memory 1904, one or more interfaces 1906, non-volatile memory 1908, and an interconnection mechanism 1914. The non-volatile memory 1908 may include executable code 1910 and, as illustrated, may additionally include at least one data store 1912.

In some implementations, the non-volatile (non-transitory) memory 1908 may include one or more read-only memory (ROM) chips; one or more hard disk drives or other magnetic or optical storage media; one or more solid state drives (SSDs), such as a flash drive or other solid-state storage media; and/or one or more hybrid magnetic and SSDs. Further in some implementations, the code 1910 stored in the non-volatile memory may include an operating system and one or more applications or programs that are configured to execute under control of the operating system. In some implementations, the code 1910 may additionally or alternatively include specialized firmware and embedded software that is executable without dependence upon a commercially available operating system. Regardless of its configuration, execution of the code 1910 may result in manipulated data that may be stored in the data store 1912 as one or more data structures. The data structures may have fields that are associated through location in the data structure. Such associations may likewise be achieved by allocating storage for the fields in locations within memory that convey an association between the fields. However, other mechanisms may be used to establish associations between information in fields of a data structure, including through the use of pointers, tags, or other mechanisms.

The processor 1902 of the computing device 1900 may be embodied by one or more processors that are configured to execute one or more executable instructions, such as a computer program specified by the code 1910, to control the operations of the computing device 1900. The function, operation, or sequence of operations can be hard coded into the circuitry or soft coded by way of instructions held in a memory device (e.g., the volatile memory 1904) and executed by the circuitry. In some implementations, the processor 1902 may be embodied by one or more application specific integrated circuits (ASICs), microprocessors, digital signal processors (DSPs), graphics processing units (GPUs), neural processing units (NPUs), microcontrollers, field programmable gate arrays (FPGAs), programmable logic arrays (PLAs), or multicore processors.

Prior to execution of the code 1910, the processor 1902 may copy the code 1910 from the non-volatile memory 1908 to the volatile memory 1904. In some implementations, the volatile memory 1904 may include one or more static or dynamic random access memory (RAM) chips and/or cache memory (e.g. memory disposed on a silicon die of the processor 1902). Volatile memory 1904 may offer a faster response time than a main memory, such as the non-volatile memory 1908.

Through execution of the code 1910, the processor 1902 may control operation of the interfaces 1906. The interfaces 1906 may include network interfaces. Such network interfaces may include one or more physical interfaces (e.g., a radio, an ethernet port, a USB port, etc.) and a software stack including drivers and/or other code 1910 that is configured to communicate with the one or more physical interfaces to support one or more LAN, PAN, and/or WAN standard communication protocols. Such communication protocols may include, for example, TCP and UDP among others. As such, the network interfaces may enable the computing device 1900 to access and communicate with other computing devices via a computer network.

The interface(s) 1906 may include one or more user interfaces. For instance, in some implementations, the user interface(s) 1906 may include user input and/or output devices (e.g., a keyboard, a mouse, a touchscreen, a display, a speaker, a camera, an accelerometer, a biometric scanner, an environmental sensor, etc.) and a software stack including drivers and/or other code 1910 that is configured to communicate with the user input and/or output devices. As such, the user interface(s) 1906 may enable the computing device 1900 to interact with users to receive input and/or render output. The rendered output may include, for example, one or more GUIs including one or more controls configured to display outputs and/or receive inputs. The received inputs may specify values to be stored in the data store 1912. The displayed outputs may indicate values stored in the data store 1912.

The various features of the computing device 1900 described above may communicate with one another via the interconnection mechanism 1914. In some implementations, the interconnection mechanism 1914 may include a communications bus.

FIG. 20 shows an example token 2002, e.g., a JSON Web Token (JWT), that may be employed by various system components as described above. As illustrated, the token 2002 may include a header 2004, a payload 2006, and a signature 2008. In some implementations, the header 2004 may specify a signing technique that was used to generate the signature 2008 based on the content of the header 2004 and/or the payload 2006, as well as a private key. In some implementations, for example, the specified signing technique may involve (A) combining the base64url encoded header and the base64url encoded payload, (B) hashing the combined base64url value with a hashing technique, e.g., SHA256, and (C) encrypting the determined hash using a private key. As such, by validating the signature 2008 using the private key and the specified signing technique, a recipient device may be able to confirm that the content of a token 2002 it receives from another device has not been altered or otherwise compromised. In some implementations, the header 2004 or payload 2006 of the token 2002 may additionally include an identifier of the device for which it was generated, thus enabling the recipient device to confirm that a received token 2002 came from the same device for which that such token 2002 was originally generated, thus restricting the use of the token 2002 by other devices to which it may have been transferred.

FIG. 21 shows an example process 2100 that may be executed by the edge image processing component 120 and/or the remote image processing component 122 (shown in FIG. 1A) to achieve certain of the functionality of the security system 100 described above in connection with FIGS. 1A and 1B, in accordance with some implementations of the present disclosure.

At a step 2110 of the process 2100, a first image processing component (e.g., an image processing module of the edge image processing component 120 and/or the remote image processing component 122 shown in FIG. 1A) may be caused to process image data (e.g., image data acquired by the image sensor 118) corresponding to an event to identify a first feature of the image data (e.g., that a frame of the image data represents motion, a person, a face, or a recognized face).

At a step 2120 of the process 2100, based at least in part the first image processing component identifying the first feature of the image data, a second image processing component (e.g., another image processing module of the edge image processing component 120 and/or the remote image processing component 122) may be caused to further process the image data to identify a second feature of the image data (e.g., that the frame of the image data represents motion, a person, a face, or a recognized face).

At a step 2130 of the process 2100, based at least in part on the second image processing component identifying the second feature of the image data, a computing device (e.g., a monitoring device 110 or a customer device 114) may be caused to output an indication relating to the event.

FIG. 22 shows an example process 2200 that may be performed by one or more components of the security system 100 (shown in FIG. 1A) to generate a timelapse bar 310, 1020 of the type described above in connection with FIGS. 3, 4, and 10A-C.

At a step 2210 of the process 2200, one or more components of a computing system (e.g., the monitoring service 106, a monitoring device 110, or a customer device 114 of the security system 100) may receive video data acquired by a camera 102 (e.g., via the image sensor 118).

At a step 2220 of the process 2200, at least one image processing component of the computing system (e.g., the edge image processing component 120 and/or the remote image processing component 122) may process the video data to determine that a first feature is represented in a first frame of the video data (e.g., that a frame of the video data represents motion, a person, a face, or a recognized face).

At a step 2230 of the process 2200, the one or more components of the computing system may store first data (e.g., one or more feature predictions 214) indicating that the first feature was identified in the first frame.

At a step 2240 of the process 2200, the one or more components of the computing system may use the first data to generate a timelapse bar (e.g., the timelapse bar 310 shown in FIG. 4) for the video data, wherein the timelapse bar includes a playback progress indicator (e.g., the playback progress indicator 402) that indicates a first relative location of a currently displayed frame within a sequence of frames of the video data, and a first feature indicator (e.g., a feature indicator 408) that indicates a second relative location of the first frame within the sequence of frames.

FIG. 23 shows example process 2300 that may be executed by the monitoring application 126 (shown in FIG. 1A) to send notifications about events to a customer 116 based on the notification preferences 704 for that customer 116 (e.g., as described above in connection with FIGS. 1A, 1C, 7, and 8A-C).

At a step 2310 of the process 2300, a first application executing on a first computing system operated by a first user (e.g., a monitoring application 126 executing on a monitoring device 110 operated by a monitoring agent 112) may receive first data representing at least a first image acquired by a camera at a property (e.g., image data acquired by the image sensor 118 shown in FIG. 1A).

At a step 2320 of the process 2300, based at least in part on the first data, the first application (e.g., the monitoring application 126) may cause the first computing system (e.g., the monitoring device 110) to output a first indication of a first event at the property, the first indication including at least the first image.

At a step 2330 of the process 2300, the first application (e.g., the monitoring application 126) may receive a first input by the first user (e.g., the monitoring agent 112) indicating that the first event is of a first type (e.g., an input identifying a cancelation reason 218 or an event disposition 220).

At a step 2340 of the process 2300, first preference data (e.g., notification preferences 704) associated with the property may be determined which indicates that notifications of events of the first type are to be sent to a second user associated with the property (e.g., a customer 116 associated with the monitored location 104).

At a step 2350 of the process 2300, based at least in part on the first input indicating that the first event is of the first type and the first preference data indicating that notifications of events of the first type are to be sent to the second user, the first application (e.g., the monitoring application 126) may cause a notification concerning the first event to be sent to an endpoint device (e.g., a customer device 114) associated with the second user, the notification causing the endpoint device to output a second indication of the first event (e.g., as a push notification, text message or an email).

FIG. 24 shows an example process 2400 that may be executed by one or more components of the security system 100 (shown in FIG. A) to allow a customer 116 to specify one or more filters that are to be applied to the events that are presented on a customer device 114, e.g., as described above in connection with the screen 902 shown in FIG. 9A.

At a step 2410 of the process 2400, one or more components of a system (e.g., the monitoring service 106 and/or a customer device 114 of the security system 100) may determine first event data for a first event and second event data for a second event at one or more properties (e.g., one or more monitored locations 104). For example, the first event data may correspond to first detected motion at one or more properties and the second event data may correspond to second detected motion. As indicated, the first event data may include first image data associated with the first event (e.g., image data 212 acquired by an image sensor 118) and may further include a first indication of a first characteristic of the first event (e.g., a location of the first event, a camera with which the first event was detected, a time of the first event, or a type of first event). Similarly, the second event data may include second image data associated with the second event (e.g., image data 212 acquired by an image sensor 118) and may further include a second indication of a second characteristic of the second event (e.g., a location of the second event, a camera with which the second event was detected, a time of the second event, or a type of the second event), wherein second characteristic is different than the first characteristic.

At a step 2420 of the process 2400, in response to a first user request to review events having the first characteristic (e.g., selection of one of the user interface elements 910, 912 shown in FIG. 9A), causing a computing device (e.g., a customer device 114) to display at least the first image data based at least on part on the first event data including the first indication.

At a step 2430 of the process 2400, in response to a second user request to review events having the second characteristic (e.g., selection of another one of the user interface elements 910, 912 shown in FIG. 9A), causing the computing device to display at least the second image data based at least on part on the second event data including the second indication.

FIG. 25 shows an example process 2500 that may be executed by the monitoring application 126 (shown in FIG. 1A) to flag events for review by a customer 116 based on the event review preferences 706 for that customer 116, e.g., as described above in connection with FIGS. 1A, 7, and 9B.

At a step 2510 of the process 2500, a first application executing on a first computing system operated by a first user (e.g., a monitoring application 126 executing on a monitoring device 110 operated by a monitoring agent 112) may receive first data representing at least a first image acquired by a camera at a property (e.g., image data acquired by the image sensor 118 shown in FIG. 1A).

At a step 2520 of the process 2500, based at least in part on the first data, the first application (e.g., the monitoring application 126) may cause the first computing system (e.g., the monitoring device 110) to output a first indication of a first event at the property, the first indication including at least the first image.

At a step 2530 of the process 2500, the first application (e.g., the monitoring application 126) may receive a first input by the first user indicating that the first event is of a first type (e.g., an input identifying a cancelation reason 218 or an event disposition 220).

At a step 2540 of the process 2500, preference data associated with the property (e.g., event review preferences 706) may be determined which indicates that events of the first type are to be flagged for review via a second application (e.g., a customer application 128).

At a step 2550 of the process 2500, based at least in part on the first input indicating that the first event is of the first type and the preference data (e.g., the event review preferences 706) indicating that events of the first type are to be flagged for review via the second application (e.g., the customer application 128), the system may cause second data (e.g., a customer review status 222) to be stored in association with the first data such that the second data causes the second application (e.g., the customer device 114) to output a prompt to review information concerning the first event (e.g., under the “events to review” tab 906 shown in FIG. 9B).

FIG. 26 shows an example process 2600 that may be executed by the customer application 128 (shown in FIG. 1A) to enable a customer 116 to provide feedback for use in altering one of more functionalities of the edge image processing component 120 and/or the remote image processing component 122, e.g., as described above in connection with FIGS. 1A, 2, 10C and 10D.

At a step 2610 of the process 2600, a first application executing on an endpoint device operated by a first user associated with a property (e.g., a customer application 128 executing on a customer device 114 operated by a customer 116 associated with a monitored location 104) may receive first data that represents at least at least a first image acquired by a camera at the property (e.g., image data acquired by an image sensor 118) and identifies a first feature of the first image that was identified by at least one image processing component (e.g., one or more image processing modules of the edge image processing component 120 and/or the remote image processing component 122) of a remote computing system.

At a step 2620 of the process 2600, based at least in part on the first data, the first application (e.g., the customer application 128) may cause the endpoint device (e.g., the customer device 114) to display the first image and a first indication of the first feature (e.g., as a thumbnail image 1022 and associated feature identifier, such as shown in FIG. 10A).

At a step 2630 of the process 2600, the first application (e.g., the customer application 128) may receive at least one input by the first user (e.g., the customer 116) corresponding to the first image (e.g., as tap and hold input, such as shown in FIG. 10C).

At a step 2640 of the process 2600, the first application (e.g., the customer application 128) may send to the remote computing system (e.g., the monitoring service 106) second data for use in altering a functionality of the at least one image processing component (e.g., by creating a new visitor profile 708 that can be by the edge image processing component 120 and/or the remote image processing component 122, or using customer feedback 224 to retrain one or more image processing modules of the edge image processing component 120 and/or the remote image processing component 122), the second data being based at least in part on the at least one input.

The following clauses describe examples of inventive concepts disclosed herein.
Clause 1. A method, comprising: receiving, by a first application executing on a first computing system operated by a first user, first data representing at least a first image acquired by a camera at a property; causing, by the first application and based at least in part on the first data, the first computing system to output a first indication of a first event at the property, the first indication including at least the first image; receiving, by the first application, a first input by the first user indicating that the first event is of a first type; determining that first preference data associated with the property indicates that notifications of events of the first type are to be sent to a second user associated with the property; and based at least in part on the first input indicating that the first event is of the first type and the first preference data indicating that notifications of events of the first type are to be sent to the second user, causing, by the first application, a notification concerning the first event to be sent to an endpoint device associated with the second user, the notification causing the endpoint device to output a second indication of the first event.
Clause 2. The method of clause 1, wherein: the first data further represents a first feature of the first image, the first feature having been determined by at least one image processing component.
Clause 3. The method of clause 2, wherein the at least one image processing component comprises at least one machine learning (ML) model.
Clause 4. The method of clause 2, wherein the at least one image processing component comprises at least a first image processing component and a second image processing component, and the method further comprises: causing the first image processing component to process the first image to identify a second feature of the first image; and causing, based at least in part the first image processing component identifying the second feature, the second image processing component to further process the first image to identify the first feature of the first image.
Clause 5. The method of clause 4, wherein the first image processing component comprise at least one first machine learning model.
Clause 6. The method of clause 4 or claim 5, wherein the second image processing component comprise at least one second machine learning model.
Clause 7. The method of any of clauses 2-6, further comprising: causing, by the first application, the first computing system to include a representation of the first feature in the first indication.
Clause 8. The method of any of clauses 2-7, further comprising: configuring, by the first application, the notification to include a representation of the first feature.
Clause 9. The method of any of clauses 2-8, wherein: the first input identifies a reason why the first feature does not present a security concern.
Clause 10. The method of clause 9, further comprising: configuring, by the first application, the notification to include an indication of the reason.
Clause 11. The method of any of clauses 1-10, further comprising: configuring, by the first application, the notification to include the first image.
Clause 12. The method of any of clauses 1-11, further comprising: configuring, by the first application, the notification to include an indication that the first event is of the first type.
Clause 13. The method of any of clauses 1-12, further comprising: receiving, by the first application, a second input by the first user corresponding to a request to send the notification to the second user; wherein the first application causes the notification to be sent to the endpoint device further based at least in part on the second input.
Clause 14. The method of any of clauses 1-13, wherein: the first data further represents a plurality of frames of video data acquired by the camera in response to detection of a motion event at the property; and the method further comprises causing, by the first application, the first computing system to playback the plurality of frames of video data.
Clause 15. The method of clause 14, wherein: the first data further represents a second feature of a first frame of the video data, the second feature having been determined by at least one image processing component; and the method further comprises generating, using the first data, a timelapse bar for the video data, wherein the timelapse bar includes a playback progress indicator that indicates a first relative location of a currently displayed frame within a sequence of frames of the video data, and a first feature indictor that indicates a second relative location of the first frame within the sequence of frames.
Clause 16. The method of any of clauses 1-15, further comprising: receiving, by the endpoint device, a third input indicating a first preference that notifications of events of the first type are to be sent to the second user; determining the first preference data based on the third input; and causing the first preference data to be stored in association with an identifier of the property.
Clause 17. The method of any of clauses 1-16, further comprising: determining that second preference data associated with the property indicates that events of the first type are to be flagged for review via a second application executing on the endpoint device; and based at least in part on the first input indicating that the first event is of the first type and the second preference data indicating that events of the first type are to be flagged for review via the second application, causing second data to be stored in association with the first data such that the second data causes the second application to output a prompt to review information concerning the first event.
Clause 18. The method of clause 17, further comprising: causing the second application to output the first image for review by the second user.
Clause 19. The method of any of clause 17 or 18, further comprising: determining actions taken by the first user while reviewing the first event; causing third data corresponding to the actions to be stored in association with the first data; and causing, based at least in part on the third data, the second application to output information indicative of the actions.
Clause 20. The method of any of clauses 2-10, further comprising: determining that second preference data associated with the property indicates that events of the first type are to be flagged for review via a second application executing on the endpoint device; based at least in part on the first input indicating that the first event is of the first type and the second preference data indicating that events of the first type are to be flagged for review via the second application, causing second data to be stored in association with the first data such that the second data causes the second application to output a prompt to review the first image; and causing the second application to output the first image and a representation of the first feature for review by the second user.
Clause 21. The method of any of clause 20, further comprising: determining actions taken by the first user while reviewing the first event; causing third data corresponding to the actions to be stored in association with the first data; and causing, based at least in part on the third data, the second application to output information indicative of the actions.
Clause 22. A method, comprising: receiving, by a first application executing on a first computing system operated by a first user, first data representing at least a first image acquired by a camera at a property; causing, by the first application and based at least in part on the first data, the first computing system to output a first indication of a first event at the property, the first indication including at least the first image; receiving, by the first application, a first input by the first user indicating that the first event is of a first type; determining that preference data associated with the property indicates that events of the first type are to be flagged for review via a second application; and based at least in part on the first input indicating that the first event is of the first type and the preference data indicating that events of the first type are to be flagged for review via the second application, causing second data to be stored in association with the first data such that the second data causes the second application to output a prompt to review information concerning the first event.
Clause 23. The method of clause 22, wherein: the first data further represents a first feature of the first image, the first feature having been determined by at least one image processing component.
Clause 24. The method of clause 23, wherein the at least one image processing component comprises at least one machine learning (ML) model.
Clause 25. The method of clause 23, wherein the at least one image processing component comprises at least a first image processing component and a second image processing component, and the method further comprises: causing the first image processing component to process the first image to identify a second feature of the first image; and causing, based at least in part the first image processing component identifying the second feature, the second image processing component to further process the first image to identify the first feature of the first image.
Clause 26. The method of clause 25, wherein the first image processing component comprise at least one first machine learning model.
Clause 27. The method of clause 25 or claim 26, wherein the second image processing component comprise at least one second machine learning model.
Clause 28. The method of any of clauses 23-27, further comprising: causing the second application to output a representation of the first feature together with the first image.
Clause 29. The method of any of clauses 23-28, wherein: the first input identifies a reason why the first feature does not present a security concern.
Clause 30. The method of clause 29, further comprising: causing the second application to output to output an indication of the reason.
Clause 31. The method of any of clauses 23-30, further comprising: causing the second application to output the first image for review by a second user of endpoint device; determining that the second user provided a second input to the second application selecting the first image; and receiving, from the second application, second data for use in altering a functionality of the at least one image processing component, the second data being based at least in part on the second input.
Clause 32. The method of clause 31, wherein the second data comprises profile data indicating that a person represented in the first image is an authorized visitor of the property.
Clause 33. The method of clause 31 or claim 32, wherein the second data comprises an indication that the first feature was inaccurately identified in the first image by the at least one image processing component.
Clause 34. The method of any of clauses 22-30, further comprising: causing the second application to output the first image for review by a second user of endpoint device.
Clause 35. The method of any of clauses 22-34, further comprising: causing the second application to output an indication that the first event is of the first type.
Clause 36. The method of any of clauses 22-35, wherein: the first data further represents a plurality of frames of video data acquired by the camera in response to detection of a motion event at the property; and the method further comprises causing the second application to playback the plurality of frames of video data.
Clause 37. The method of clause 36, wherein: the first data further represents a second feature of a first frame of the video data, the second feature having been determined by at least one image processing component; and the method further comprises generating, using the first data, a timelapse bar for the video data, wherein the timelapse bar includes a playback progress indicator that indicates a first relative location of a currently displayed frame within a sequence of frames of the video data, and a first feature indictor that indicates a second relative location of the first frame within the sequence of frames.
Clause 38. The method of any of clauses 22-37, further comprising: receiving, by the second application, a second input indicating a first preference that notifications of events of the first type are to be flagged for review via the second application; determining the preference data based on the second input; and causing the preference data to be stored in association with an identifier of the property.
Clause 39. The method of any of clauses 22-38, further comprising: determining actions taken by the first user while reviewing the first event; causing third data corresponding to the actions to be stored in association with the first data; and causing, based at least in part on the third data, the second application to output information indicative of the actions.
Clause 40. A method, comprising: receiving, by a computing system, video data acquired by a camera; processing, by at least one image processing component of the computing system, the video data to determine that a first feature is represented in a first frame of the video data; storing, by the computing system, first data indicating that the first feature was identified in the first frame; and generating, by the computing system and using the first data, a timelapse bar for the video data, wherein the timelapse bar includes a playback progress indicator that indicates a first relative location of a currently displayed frame within a sequence of frames of the video data, and a first feature indicator that indicates a second relative location of the first frame within the sequence of frames.
Clause 41. The method of clause 40, wherein the first feature comprises detected motion.
Clause 42. The method of clause 40, wherein the first feature comprises a detected person.
Clause 43. The method of clause 40, wherein the first feature comprises a detected face.
Clause 44. The method of clause 40, wherein the first feature comprises a recognized face.
Clause 45. The method of any of clauses 40-44, wherein the first feature is of a first feature type, and the method further comprises: processing, by the computing system, the video data to determine that a second feature of a second feature type, which is different than the first feature type, is represented in a second frame of the video data; storing, by the computing system, second data indicating that the second feature was identified in the second frame; and generating, by the computing system and using the second data, the timelapse bar to include a second feature indicator that indicates a third relative location of the second frame within the sequence of frames.
Clause 46. The method of clause 45, wherein the second feature comprises detected motion.
Clause 47. The method of clause 45, wherein the second feature comprises a detected person.
Clause 48. The method of clause 45, wherein the second feature comprises a detected face.
Clause 49. The method of clause 45, wherein the second feature comprises a recognized face.
Clause 50. The method of any of clauses 45-49, further comprising: generating the first feature indicator to have at least one first characteristic corresponding to the first feature type; and generating the second feature indicator to have at least one second characteristic corresponding to the second feature type, wherein the at least one second characteristic is different than the at least one first characteristic.
Clause 51. The method of clause 50, wherein: the at least one first characteristic includes a first color; and the at least one second characteristic includes a second color, wherein the second color is different than the first color.
Clause 52. The method of clause 50 or claim 49, wherein: the at least one first characteristic includes a first vertical position relative to the playback progress indicator; and the at least one second characteristic includes a second vertical position relative to the playback progress indicator, wherein the second vertical position is different than the first vertical position.
Clause 53. The method of any of clauses 40-52, wherein the at least one image processing component comprises at least one machine learning (ML) model.
Clause 54. The method of any of clauses 40-53, wherein the at least one image processing component comprises at least a first image processing component and a second image processing component, and the method further comprises: causing the first image processing component to process the first frame to identify a second feature of the first frame; and causing, based at least in part the first image processing component identifying the second feature, the second image processing component to further process the first frame to identify the first feature of the first frame.
Clause 55. The method of clause 54, wherein the first image processing component comprise at least one first machine learning model.
Clause 56. The method of clause 54 or claim 53, wherein the second image processing component comprise at least one second machine learning model.
Clause 57. The method of any of clauses 40-56, wherein: timelapse bar is configured to cause playback of the video data to jump to a frame of the video data corresponding to a selected location on the playback progress indicator.
Clause 58. A method, comprising: determining first event data for a first event corresponding to detected motion at one or more properties and second event data for a second event corresponding to detected motion at the one or more properties, wherein the first event data includes first image data associated with the first event and further includes a first indication of a first characteristic of the first event, and the second event data includes second image data associated with the second event and further includes a second indication of a second characteristic of the second event, the second characteristic being different than the first characteristic; in response to a first user request to review events having the first characteristic, causing a computing device to display at least the first image data based at least on part on the first event data including the first indication; and in response to a second user request to review events having the second characteristic, causing the computing device to display at least the second image data based at least on part on the second event data including the second indication.
Clause 59. The method of clause 58, wherein: the first characteristic comprises a first property at which the first event was detected; the first indication comprises a first identifier of the first property; the second characteristic comprises a second property at which the second event was detected, wherein the second property is different from the first property; and the second indication comprises a second identifier of the second property.
Clause 60. The method of clause 58, wherein: the first characteristic comprises a first date on which the first event was detected; the first indication comprises a first identifier of the first date; the second characteristic comprises a second date on which the second event was detected, wherein the second date is different than the first date; and the second indication comprises a second identifier of the second date.
Clause 61. The method of clause 58, wherein: the first characteristic comprises a first camera that was used to detect the first event; the first indication comprises a first identifier of the first camera; the second characteristic comprises a second camera that was used to detect the second event, wherein the second camera is different from the first camera; and the second indication comprises a second identifier of the second camera.
Clause 62. The method of clause 58, wherein: the first characteristic comprises a first event type; the first indication comprises a first identifier of the first event type; the second characteristic comprises a second event type, wherein the second event type is different than the first event type; and the second indication comprises a second identifier of the second event type.
Clause 63. The method of clause 62, wherein the first event type comprises a detected motion event.
Clause 64. The method of clause 62, wherein the first event type comprises a detected person event.
Clause 65. The method of clause 62, wherein the first event type comprises a detected face event.
Clause 66. The method of clause 62, wherein the first event type comprises a recognized face event.
Clause 67. The method of any of clauses 64-66, wherein the second event type comprises a detected motion event.
Clause 68. The method of clause 63, claim 63, or claim 64, wherein the first event type comprises a detected person event.
Clause 69. The method of clause 63, claim 62, or claim 64, wherein the second event type comprises a detected face event.
Clause 70. The method of any of clauses 63-65, wherein the second event type comprises a recognized face event.
Clause 71. The method of any of clauses 62-70, further comprising: determining that a user provided an input to the computing device selecting an image corresponding to the first event; and receiving, from the computing device, feedback data for use in altering a functionality of at least one image processing component that was used to determine the first event type, the feedback data being based at least in part on the input.
Clause 72. The method of clause 71, wherein the feedback data comprises profile data indicating that a person represented in the image is an authorized visitor of the one or more properties.
Clause 73. The method of clause 71 or claim 72, wherein the feedback data comprises an indication that the first event type was inaccurately identified in the image by the at least one image processing component.
Clause 74. The method of any of clauses 58-73, further comprising: determining actions taken by a monitoring agent while reviewing the first event; and causing the computing device to output information indicative of the actions.
Clause 75. A method, comprising: causing a first image processing component to process image data corresponding to an event to identify a first feature of the image data; causing, based at least in part the first image processing component identifying the first feature of the image data, a second image processing component to further process the image data to identify a second feature of the image data; and based at least in part on the second image processing component identifying the second feature of the image data, causing a computing device to output an indication relating to the event.
Clause 76. The method of clause 75, wherein the first image processing component comprise at least one first machine learning model.
Clause 77. The method of any of clause 75 or claim 76, wherein the second image processing component comprise at least one second machine learning model.
Clause 78. The method of any of clauses 75-77, wherein the first image processing component performs edge processing for a camera that captured the image data.
Clause 79. The method of any of clauses 75-77, wherein the first image processing component performs cloud-based processing of at least a portion of the image data.
Clause 80. The method of any of clauses 75-79, wherein the second image processing component performs cloud-based processing of at least a portion of the image data.
Clause 81. The method of any of clauses 75-80, wherein causing the first image processing component to process the image data further comprises: causing the first image processing component to identify one or more key frames of the image data that potentially represent the second feature.
Clause 82. The method of clause 81, wherein causing the second image processing component to further process the image data further comprises: causing the second image processing component to process the one or more key frames to perform motion detection.
Clause 83. The method of clause 81, wherein causing the second image processing component to further process the image data further comprises: causing the second image processing component to process the one or more key frames to perform person detection.
Clause 84. The method of clause 81, wherein causing the second image processing component to further process the image data further comprises: causing the second image processing component to process the one or more key frames to perform face detection.
Clause 85. The method of clause 81, wherein causing the second image processing component to further process the image data further comprises: causing the second image processing component to process the one or more key frames to perform facial recognition.
Clause 86. The method of any of clauses 75-80, wherein: causing the first image processing component to process the image data further comprises causing the first image processing component to identify one or more first frames of the image data that represent motion; causing the second image processing component to further process the image data comprises causing the second image processing component to perform person detection on the one or more first frames; and the computing device is caused to output the indication further based at least in part on a person being detected in the one or more first frames.
Clause 87. The method of clause 86, further comprising: causing, based at least in part the second image processing component detecting a person in one or more second frames of the one or more first frames, a third image processing component to perform face detection on the one or more second frames; and the computing device is caused to output the indication further based at least in part on a face being detected in the one or more second frames.
Clause 88. The method of clause 87, further comprising: causing, based at least in part the third image processing component detecting a face in one or more third frames of the one or more second frames, a fourth image processing component to perform facial recognition on the one or more third frames; and the computing device is caused to output the indication further based at least in part on a face being recognized in the one or more third frames.
Clause 89. The method of any of clauses 75-80, wherein: causing the first image processing component to process the image data further comprises causing the first image processing component to identify one or more first frames of the image data that represent a person; causing the second image processing component to further process the image data comprises causing the second image processing component to perform face detection on the one or more first frames; and the computing device is caused to output the indication further based at least in part on a face being detected in the one or more first frames.
Clause 90. The method of clause 89, further comprising: causing, based at least in part the second image processing component detecting a face in one or more second frames of the one or more first frames, a third image processing component to perform facial recognition on the one or more second frames; and the computing device is caused to output the indication further based at least in part on a face being recognized in the one or more second frames.
Clause 91. The method of any of clauses 75-80, wherein: causing the first image processing component to process the image data further comprises causing the first image processing component to identify one or more first frames of the image data that represent a face; causing the second image processing component to further process the image data comprises causing the second image processing component to perform facial recognition on the one or more first frames; and the computing device is caused to output the indication further based at least in part on a face being recognized in the one or more first frames.
Clause 92. A method, comprising: receiving, by a first application executing on an endpoint device operated by a first user associated with a property, first data that represents at least at least a first image acquired by a camera at the property and identifies a first feature of the first image that was identified by at least one image processing component of a remote computing system; causing, by the first application and based at least in part on the first data, the endpoint device to display the first image and a first indication of the first feature; receiving, by the first application, at least one input by the first user corresponding to the first image; and sending, from the first application to the remote computing system, second data for use in altering a functionality of the at least one image processing component, the second data being based at least in part on the at least one input.
Clause 93. The method of clause 92, wherein the second data comprises profile data indicating that a person represented in the first image is an authorized visitor of the property.
Clause 94. The method of clause 93, further comprising: causing the at least one image processing component to use the profile data to perform facial recognition corresponding to the person represented in the first image.
Clause 95. The method of any of clauses 92-94, wherein the second data comprises a second indication that the first feature was inaccurately identified in the first image by the at least one image processing component.
Clause 96. The method of clause 95, further comprising: using the second indication to retain the at least one image processing component.
Clause 97. The method of any of clauses 92-96, wherein the at least one input comprises a tap-and-hold gesture on the first image displayed by the endpoint device.
Clause 98. The method of any of clauses 92-97, wherein the at least one image processing component comprises at least one machine learning model.
Clause 99. The method of any of clauses 92-98, wherein the at least one image processing component comprises at least a first image processing component and a second image processing component, and the method further comprises: causing the first image processing component to process the first image to identify a second feature of the first image; and causing, based at least in part the first image processing component identifying the second feature, the second image processing component to further process the first image to identify the first feature of the first image.
Clause 100. The method of clause 99, wherein the first image processing component comprise at least one first machine learning model.
Clause 101. The method of clause 99 or claim 100, wherein the second image processing component comprise at least one second machine learning model.
Clause 102. A method, comprising: receiving, by a first application executing on a first computing system operated by a first user, first data representing at least a first image acquired by a camera at a property; causing, by the first application and based at least in part on the first data, the first computing system to output a first indication of a first event at the property, the first indication including at least the first image; receiving, by the first application, a first input by the first user indicating that the first event is of a first type; determining that preference data associated with the property indicates that events of the first type are to be flagged for review via a second application; and based at least in part on the first input indicating that the first event is of the first type and the preference data indicating that events of the first type are to be flagged for review via the second application, causing second data to be stored in association with the first data such that the second data causes the second application to output a prompt to review information concerning the first event.
Clause 103. The method of clause 102, wherein: the first data further represents a first feature of the first image, the first feature having been determined by at least one image processing component.
Clause 104. The method of clause 103, further comprising: causing the second application to output a representation of the first feature together with the first image.
Clause 105. The method of clause 103 or clause 104, wherein: the first input indicates that the first feature is free of a security concern.
Clause 106. The method of any of clauses 103-105, further comprising: causing the second application to output to output an indication that the first feature is free of a security concern.
Clause 107. The method of any of clauses 102-106, further comprising: receiving, by the second application, a second input indicating a first preference that notifications of events of the first type are to be flagged for review via the second application; and determining the preference data based on the second input.
Clause 108. A method, comprising: determining first event data for a first event corresponding to detected motion at one or more properties and second event data for a second event corresponding to detected motion at the one or more properties, wherein the first event data includes first image data associated with the first event and further includes a first indication of a first characteristic of the first event, and the second event data includes second image data associated with the second event and further includes a second indication of a second characteristic of the second event, the second characteristic being different than the first characteristic; in response to a first user request to review events having the first characteristic, causing a computing device to display at least the first image data based at least on part on the first event data including the first indication; and in response to a second user request to review events having the second characteristic, causing the computing device to display at least the second image data based at least on part on the second event data including the second indication.
Clause 109. The method of clause 108, wherein: the first characteristic includes a first property at which the first event was detected; the first indication includes a first identifier of the first property; the second characteristic includes a second property at which the second event was detected, wherein the second property is different from the first property; and the second indication includes a second identifier of the second property.
Clause 110. The method of clause 108, wherein: the first characteristic includes a first date on which the first event was detected; the first indication includes a first identifier of the first date; the second characteristic includes a second date on which the second event was detected, wherein the second date is different than the first date; and the second indication includes a second identifier of the second date.
Clause 111. The method of clause 108, wherein: the first characteristic includes a first camera that was used to detect the first event; the first indication includes a first identifier of the first camera; the second characteristic includes a second camera that was used to detect the second event, wherein the second camera is different from the first camera; and the second indication includes a second identifier of the second camera.
Clause 112. The method of clause 108, wherein: the first characteristic includes a first event type; the first indication includes a first identifier of the first event type; the second characteristic includes a second event type, wherein the second event type is different than the first event type; and the second indication includes a second identifier of the second event type.
Clause 113. The method of clause 112, wherein the first event type includes a detected motion event.
Clause 114. The method of clause 112 or clause 113, wherein the second event type includes a detected person event.
Clause 115. A method, comprising: causing a first image processing component to process image data corresponding to an event to identify a first feature of the image data; causing, based at least in part the first image processing component identifying the first feature of the image data, a second image processing component to further process the image data to identify a second feature of the image data; and based at least in part on the second image processing component identifying the second feature of the image data, causing a computing device to output an indication relating to the event.
Clause 116. The method of clause 115, wherein the first image processing component is included in a camera that captured the image data.
Clause 117. The method of clause 116, wherein the second image processing component is remote from the camera that captured the image data.
Clause 118. The method of any of clauses 115-117, wherein causing the first image processing component to process the image data further comprises: causing the first image processing component to identify one or more key frames of the image data that potentially represent the second feature.
Clause 119. The method of clause 118, wherein causing the second image processing component to further process the image data further comprises: causing the second image processing component to process the one or more key frames to perform person detection.
Clause 120. The method of clause 118, wherein causing the second image processing component to further process the image data further comprises: causing the second image processing component to process the one or more key frames to perform face detection.
Clause 121. The method of clause 118, wherein causing the second image processing component to further process the image data further comprises: causing the second image processing component to process the one or more key frames to perform facial recognition.
Clause 122. A system, comprising: one or more processors; and one or more non-transitory computer-readable mediums encoded with instructions which, when executed by the one or more processors, cause the system to perform the method of any of clauses 1-121.
Clause 123. One or more non-transitory computer-readable mediums encoded with instructions which, when executed by one or more processors of a system, cause the system to perform the method of any of clauses 1-121.

Various inventive concepts may be embodied as one or more methods, of which examples have been provided. The acts performed as part of a method may be ordered in any suitable way. Accordingly, examples may be constructed in which acts are performed in an order different than illustrated, which may include performing some acts simultaneously, even though shown as sequential acts in illustrative examples.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements.

The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

Having described several examples in detail, various modifications and improvements will readily occur to those skilled in the art. Such modifications and improvements are intended to be within the scope of this disclosure. Accordingly, the foregoing description is by way of example only, and is not intended as limiting.

What is claimed is:

1. A method, comprising:
receiving, by a first application executing on a first computing system operated by a monitoring agent, first data representing recorded video of a first event, the recorded video having been acquired by a camera at a property;
causing, by the first application and based at least in part on the first data, the first computing system to output the recorded video;
after causing the first computing system to output the recorded video, receiving, by the first application, a first input from the monitoring agent identifying a first event type category, selected from among at least three predetermined event type categories, within which the first event has been categorized;
based at least in part on the first input identifying the first event type category, causing, by the first application, second data to be stored in a datastore, the second data indicative of the first event type category; and
in response to receipt of a first indication that a first user interface element of a second application of a user has been selected, causing, based at least in part on the second data in the datastore, the second application to output first information concerning the first event.

2. The method of claim 1, wherein the first data further represents a first feature of a frame of the recorded video, the first feature having been determined by at least one image processing component, and the method further comprises:
causing the first information to include a representation of the first feature together with the frame.

3. (canceled)

4. The method of claim 2, wherein the first input indicates that the first feature is free of a security concern, and the method further comprises causing the first information to include an indication that the first feature is free of a security concern.

5. (canceled)

6. The method of claim 35, further comprising:
receiving, by the second application, a second input indicating a first preference that events categorized within the first event type category be flagged for review via the second application; and
determining the preference data based on the second input.

7-20. (canceled)

21. A system, comprising:
one or more processors; and
one or more computer-readable mediums encoded with instructions which, when executed by the one or more processors, cause the system to:
receive, by a first application executing on a first computing system operated by a monitoring agent, first data representing recorded video of a first event, the recorded video having been acquired by a camera at a property;
cause, by the first application and based at least in part on the first data, the first computing system to output the recorded video;
after the first computing system has been caused to output the recorded video, receive, by the first application, a first input from the monitoring agent identifying a first event type category, selected from among at least three predetermined event type categories, within which the first event has been categorized;
based at least in part on the first input identifying the first event type category, cause, by the first application, second data to be stored in a datastore, the second data indicative of the first event type category; and
in response to receipt of a first indication that a first user interface element of a second application of a user has been selected, cause, based at least in part on the second data in the datastore, the second application to output first information concerning the first event.

22. The system of claim 21, wherein the first data further represents a first feature of a frame of the recorded video, the first feature having been determined by at least one image processing component, and the one or more computer-readable mediums are further encoded with additional instructions which, when executed by the one or more processors, further cause the system to:
cause the first information to include a representation of the first feature together with the frame.

23. (canceled)

24. The system of claim 22, wherein the first input indicates that the first feature is free of a security concern, and the one or more computer-readable mediums are further encoded with additional instructions which, when executed by the one or more processors, further cause the system to:
cause the first information to include an indication that the first feature is free of a security concern.

25. (canceled)

26. The system of claim 34, wherein the one or more computer-readable mediums are further encoded with additional instructions which, when executed by the one or more processors, further cause the system to:
receive, by the second application, a second input indicating a first preference that events categorized within the first event type category be flagged for review via the second application; and
determine the preference data based on the second input.

27-33. (canceled)

34. The system of claim 42, wherein the one or more computer-readable mediums are further encoded with additional instructions which, when executed by the one or more processors, further cause the system to:
determine that preference data associated with the property indicates that events within the first event type category are to be flagged for review via the second application; and
cause the third data to be stored in the datastore further based at least in part on the preference data indicating that events within the first event type category are to be flagged for review.

35. The method of claim 36, further comprising:
determining that preference data associated with the property indicates that events within the first event type category are to be flagged for review via the second application;
wherein causing the third data to be stored in the datastore is further based at least in part on the preference data indicating that events within the first event type category are to be flagged for review.

36. The method of claim 1, wherein selection of the first user interface element represents a request to review events that have been flagged for review by the user, and the method further comprises:
storing, based on the second data in the datastore, third data in the datastore, the third data indicating that the first event has been flagged for review by the user; and
determining to cause the second application to output the first information based on the third data in the datastore.

37. The method of claim 36, further comprising:
after causing the second application to output the first information and in response to receipt of a second indication that a second user interface element of the second application has been selected, causing the third data to be removed from the datastore.

38. The method of claim 1, further comprising:
after causing the second application to output the first information and in response to receipt of a second indication that a second user interface element of the second application has been selected, causing the second application to output the recorded video of the first event.

39. The method of claim 1, further comprising:
after causing the second application to output the first information and in response to receipt of a second indication that a second user interface element of the second application has been selected, causing the second application to output second information indicative of times at which one or more features were detected in the recorded video for the first event.

40. The method of claim 1, further comprising:
after causing the second application to output the first information and in response to receipt of a second indication that a second user interface element of the second application has been selected, causing the second application to output second information indicative of one or more actions taken by the monitoring agent while reviewing the first event.

41. The method of claim 1, wherein selection of the first user interface element represents a request to review events of a first type, and the method further comprises:
determining, based on the second data in the datastore, that the first event is of the first type; and
determining to cause the second application to output the first information based on the first event being of the first type.

42. The system of claim 21, wherein selection of the first user interface element represents a request to review events that have been flagged for review by the user, and the one or more computer-readable mediums are further encoded with additional instructions which, when executed by the one or more processors, further cause the system to:
store, based on the second data in the datastore, third data in the datastore, the third data indicating that the first event has been flagged for review by the user; and
determine to cause the second application to output the first information based on the third data in the datastore.

43. The system of claim 42, wherein the one or more computer-readable mediums are further encoded with additional instructions which, when executed by the one or more processors, further cause the system to:
after causing the second application to output the first information and in response to receipt of a second indication that a second user interface element of the second application has been selected, cause the third data to be removed from the datastore.

44. The system of claim 21, wherein the one or more computer-readable mediums are further encoded with additional instructions which, when executed by the one or more processors, further cause the system to:
after causing the second application to output the first information and in response to receipt of a second indication that a second user interface element of the second application has been selected, cause the second application to output the recorded video of the first event.

45. The system of claim 21, wherein the one or more computer-readable mediums are further encoded with additional instructions which, when executed by the one or more processors, further cause the system to:
after causing the second application to output the first information and in response to receipt of a second indication that a second user interface element of the second application has been selected, cause the second application to output second information indicative of times at which one or more features were detected in the recorded video for the first event.

46. The system of claim 21, wherein the one or more computer-readable mediums are further encoded with additional instructions which, when executed by the one or more processors, further cause the system to:
after causing the second application to output the first information and in response to receipt of a second indication that a second user interface element of the second application has been selected, cause the second application to output second information indicative of one or more actions taken by the monitoring agent while reviewing the first event.

47. The system of claim 21, wherein selection of the first user interface element represents a request to review events of a first type, and the one or more computer-readable mediums are further encoded with additional instructions which, when executed by the one or more processors, further cause the system to:
determine, based on the second data in the datastore, that the first event is of the first type; and
determine to cause the second application to output the first information based on the first event being of the first type.
